(19) United States
(12) Patent Application Publication
(10) Pub. No.: US 2024/0375406 A1
(43) Pub. Date: Nov. 14, 2024

(54) LIQUID DISCHARGE HEAD

(71) Applicant: CANON KABUSHIKI KAISHA, Tokyo (JP)

(72) Inventors: TAKEHO MIYASHITA, Kanagawa (JP); YUJI TAMARU, Tokyo (JP); SHIMPEI YOSHIKAWA, Kanagawa (JP); RYO SATO, Tokyo (JP)

(21) Appl. No.: 18/645,644

(22) Filed: Apr. 25, 2024

(30) Foreign Application Priority Data
May 8, 2023 (JP) 2023-076761

(51) Int. Cl. B41J 2/18; B41J 2/14; B41J 2/15

(52) U.S. Cl. CPC B41J 2/18; B41J 2/14112; B41J 2/15

(57) ABSTRACT

A liquid discharge head includes: a first discharge port array configured of a plurality of discharge ports lined up in a first direction; a second discharge port array configured of a plurality of discharge ports lined up in the first direction; an opening forming portion; and a circulatory portion. The opening forming portion includes: a first supply opening for supplying the liquid to a discharge port of the first discharge port array; a first collecting opening for collecting the liquid; a second supply opening for supplying the liquid to a discharge port of the second discharge port array; and a second collecting opening for collecting the liquid. The second supply opening is offset in the first direction with respect to the first supply opening.

### BACKGROUND OF THE INVENTION

### Field of the Invention

The present invention relates to a liquid discharge head.

### Description of the Related Art

Conventionally, an inkjet recording apparatus, the main body of which is mounted with an ink tank, is known as a liquid discharge apparatus which performs a recording operation on a recording medium by using a liquid discharge head that discharges a liquid such as ink towards the recording medium. In such an apparatus, ink stored in a liquid storage portion is supplied to a discharge head so as to be discharged therefrom.

An inkjet recording apparatus such as that described above may be configured to cause ink to be circulated between the liquid discharge head and the liquid storage portion or inside the liquid discharge head. Japanese Patent Application Laid-open No. 2019-177550 discloses a configuration in which a scanning liquid discharge head causes ink to be circulated inside the liquid discharge head.

### SUMMARY OF THE INVENTION

However, in the configuration described above, when a temperature of the ink changes upon ink discharge, there is a concern about a difference in temperatures being created between a supply flow path and a collecting flow path of ink since ink that has not been discharged is collected at the changed temperature. When the temperature changes in a discharge port array direction and a temperature non-uniformity is created near a discharge portion of the liquid discharge head, print non-uniformity may occur during printing.

In consideration of the problem described above, an object of the present invention is to provide a liquid discharge head capable of suppressing print non-uniformity.

In order to achieve the object described above, a recording head according to the present invention includes:
a first discharge port array configured of a plurality of discharge ports lined up in a first direction from which a liquid is discharged;
a second discharge port array configured of a plurality of discharge ports lined up in the first direction, the second discharge port array being arranged at a position overlapping with the first discharge port array in a second direction orthogonal to the first direction in a case of being viewed from a discharge direction of the liquid;
an opening forming portion including a first supply opening for supplying the liquid to a discharge port of the first discharge port array, a first collecting opening for collecting the liquid that has not been discharged from the discharge port of the first discharge port array, a second supply opening for supplying the liquid to a discharge port of the second discharge port array, and a second collecting opening for collecting the liquid that has not been discharged from the discharge port of the second discharge port array; and
a circulatory portion which causes the liquid to circulate through the first supply opening, the first collecting opening, the second supply opening, and the second collecting opening,
wherein the second supply opening is offset in the first direction with respect to the first supply opening.

In addition, in order to achieve the object described above, a recording head according to the present invention includes:
a first discharge port array configured of a plurality of discharge ports lined up in a first direction from which a liquid is discharged;
a second discharge port array configured of a plurality of discharge ports lined up in the first direction, the second discharge port array being arranged at a position overlapping with the first discharge port array in a second direction orthogonal to the first direction in a case of being viewed from a discharge direction of the liquid;
an opening forming portion including a first supply opening for supplying the liquid to a discharge port of the first discharge port array, a first collecting opening for collecting the liquid that has not been discharged from the discharge port of the first discharge port array, a second supply opening for supplying the liquid to a discharge port of the second discharge port array, and a second collecting opening for collecting the liquid that has not been discharged from the discharge port of the second discharge port array; and
a circulatory portion which causes the liquid to circulate through the first supply opening, the first collecting opening, the second supply opening, and the second collecting opening,
wherein the second collecting opening is offset in the first direction with respect to the first collecting opening.

According to the present invention, a liquid discharge head capable of suppressing print non-uniformity can be provided.

Further features of the present invention will become apparent from the following description of exemplary embodiments with reference to the attached drawings.

### BRIEF DESCRIPTION OF THE DRAWINGS

FIGS. 1A and 1B are schematic configuration diagram of a liquid discharge apparatus according to a first embodiment;

FIGS. 2A to 2C are explanatory diagrams of a recording head according to the first embodiment;

FIG. 3 is a lower view of the recording head according to the first embodiment;

FIG. 4 is a schematic perspective view showing a schematic configuration of a circulation unit according to the first embodiment;

FIG. 5 is an explanatory diagram of an ink flow path of the recording head according to the first embodiment;

FIG. 6 is a block diagram of the ink flow path of the recording head according to the first embodiment;

FIGS. 7A to 7C are explanatory diagrams of pressure adjusting means of the recording head according to the first embodiment;

FIGS. 8A and 8B are external perspective views of a circulation pump according to the first embodiment;

FIG. 9 is a sectional view taken along line IX-IX in FIGS. 8A and 8B;

FIGS. 10A to 10E are explanatory diagrams of a flow of ink in the recording head according to the first embodiment;

FIGS. 11A and 11B are exploded perspective views of a recording element unit according to the first embodiment;

FIG. 12 is a schematic top view of an opening plate according to the first embodiment;

FIG. 13 is a schematic top view of a recording element substrate according to the first embodiment;

FIG. 14 is an explanatory diagram of a bonding state between the opening plate and the recording element substrate according to the first embodiment;

FIGS. 15A to 15C are schematic sectional views of an ink flow path of the recording element unit according to the first embodiment;

FIG. 16 is an explanatory diagram of a temperature distribution of a discharge module;

FIG. 17 is an explanatory diagram of an arrangement configuration of supply openings and collecting openings according to the first embodiment;

FIG. 18 is an explanatory diagram of temperature distributions of two discharge modules according to the first embodiment;

FIG. 19 is an explanatory diagram of a bonding state between an opening plate and a recording element substrate according to a second embodiment;

FIG. 20 is an explanatory diagram of an arrangement configuration of supply openings and collecting openings according to the second embodiment;

FIG. 21 is an explanatory diagram of temperature distributions of two discharge modules according to the second embodiment; and

FIG. 22 is an explanatory diagram of an arrangement configuration of supply openings and collecting openings according to a third embodiment.

### DESCRIPTION OF THE EMBODIMENTS

Hereinafter, a description will be given, with reference to the drawings, of embodiments (examples) of the present invention. However, the sizes, materials, shapes, their relative arrangements, or the like of constituents described in the embodiments may be appropriately changed according to the configurations, various conditions, or the like of apparatuses to which the invention is applied. Therefore, the sizes, materials, shapes, their relative arrangements, or the like of the constituents described in the embodiments do not intend to limit the scope of the invention to the following embodiments. In addition, not all features described in the following embodiments are essential to solutions provided by the invention.

### First Embodiment

### Liquid Discharge Apparatus

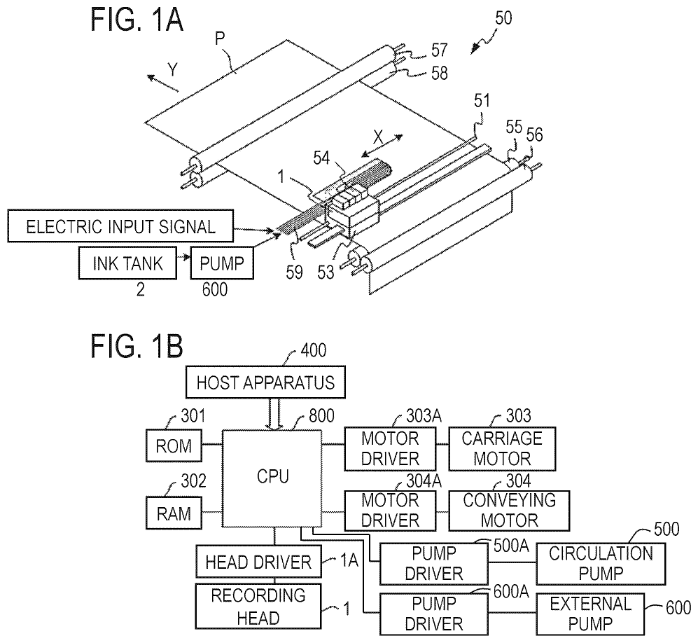

First, a schematic configuration of a liquid discharge apparatus 50 of a first embodiment according to the present invention will be described with reference to FIGS. 1A and 1B. FIG. 1A is a perspective view schematically showing the liquid discharge apparatus 50 including a recording head 1 and showing a recording medium P being conveyed in and around the recording head 1. The liquid discharge apparatus 50 according to the first embodiment constitutes a serial inkjet recording apparatus which performs recording on the recording medium P by discharging ink as a liquid while scanning the recording medium P with the recording head 1.

The recording head 1 is mounted on a carriage 53. The carriage 53 reciprocates in a main scanning direction (X direction) along a guide shaft 51. The recording medium P is conveyed in a sub-scanning direction (Y direction) which intersects with (in the present example, orthogonal to) the main scanning direction by conveying rollers 55, 56, 57, and 58. Note that in each of the drawings to be referred to below, a Z direction represents a vertical direction which intersects with (in the present example, orthogonal to) an X-Y plane defined by the X direction and the Y direction. The recording head 1 is configured to be detachable from and attachable to the carriage 53 by a user.

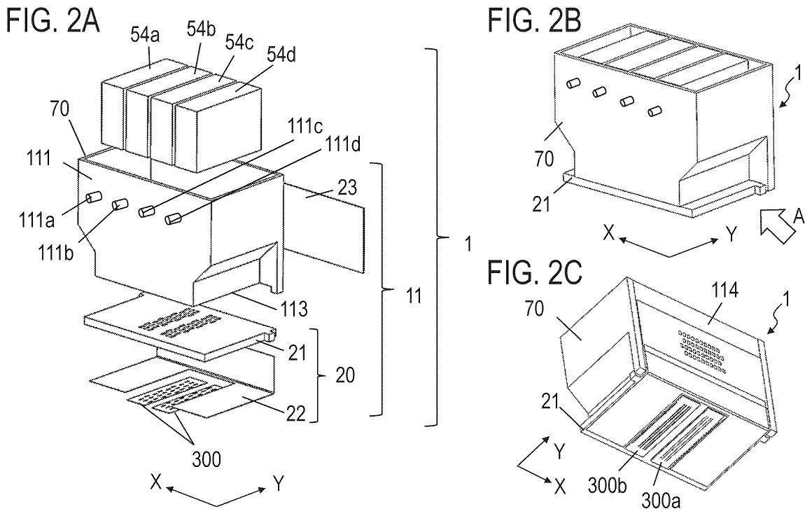

The recording head 1 is a liquid discharge head configured so as to include a circulation unit 54 as a circulatory portion which causes ink to circulate inside the recording head 1 and a discharge unit 11 (refer to FIGS. 2A to 2C) for discharging the ink. While a specific configuration will be described later, the discharge unit 11 is provided with a plurality of discharge ports and an energy generation element (hereinafter, referred to as discharge elements) which generate discharge energy for discharging a liquid from each discharge port. The recording head 1 is a thermal-system liquid discharge head which discharges a liquid by generating air bubbles with a thermoelectric conversion element as the discharge element that discharges the liquid.

In addition, the liquid discharge apparatus 50 is provided with an ink tank 2 which is a supply source of the ink and an external pump 600, and the ink stored in the ink tank 2 is supplied to the circulation unit 54 via an ink supply tube 59 by a driving force of the external pump 600.

The liquid discharge apparatus 50 forms a prescribed image on the recording medium P by repetitively performing a recording scan in which the recording head 1 mounted to the carriage 53 discharges ink and performs recording while moving in the main scanning direction and a conveying operation of conveying the recording medium P in the sub-scanning direction. Note that the recording head 1 in the first embodiment is capable of discharging four types of ink, namely, black (K), cyan (C), magenta (M), and yellow (Y) and capable of recording full-color images using these inks. However, the inks that can be discharged from the recording head 1 are not limited to the four types of ink described above. The present disclosure is also applicable to liquid discharge heads for discharging other types of ink. In other words, there are no limits to the types and numbers of ink to be discharged from the recording head 1.

In addition, the liquid discharge apparatus 50 is provided with a cap member (not illustrated) capable of covering a discharge port surface on which the discharge ports of the recording head 1 are formed at a position distanced in the X direction from a conveying path of the recording medium P. The cap member covers the discharge port surface of the recording head 1 when a recording operation is not being performed and is used to prevent drying and to protect the discharge ports, perform an ink suction operation from the discharge ports, and the like.

Note that while the recording head 1 shown in FIG. 1A represents an example in which the recording head 1 is provided with four circulation units 54 corresponding to four types of ink, circulation units 54 corresponding to the types of liquid to be discharged need only be provided. In addition, a plurality of the circulation units 54 may be provided with respect to liquids of a same type. In other words, the recording head 1 can be configured to include one or more circulation units. A configuration may be adopted in which only at least one type of ink is circulated instead of causing all four types of ink to be circulated.

FIG. 1B is a block diagram showing a control system of the liquid discharge apparatus 50. A CPU 800 functions as control means which controls operations of each portion of the liquid discharge apparatus 50 based on a program of processing procedures or the like stored in a ROM 301. A RAM 302 is used as a work area when the CPU 800 executes processing or the like. The CPU 800 receives image data from a host apparatus 400 outside of the liquid discharge apparatus 50 and controls a head driver 1A and controls driving of a discharge element provided in the discharge unit 11. In addition, the CPU 800 also controls drivers of various actuators that are provided in the liquid discharge apparatus 50. For example, the CPU 800 controls a motor driver 303A of a carriage motor 303 for moving the carriage 53, a motor driver 304A of a conveying motor 304 for conveying the recording medium P, and the like. Furthermore, the CPU 800 controls a pump driver 500A that drives a circulation pump 500 to be described later, a pump driver 600A of the external pump 600, and the like. While FIG. 1B shows a mode of performing processing of receiving image data from the host apparatus 400, processing may be performed by the liquid discharge apparatus 50 independently of data from the host apparatus 400.

### Basic Configuration of Recording Head

A configuration of the recording head 1 will now be described in greater detail. FIG. 2A is an exploded perspective view of the recording head 1, FIG. 2B is a perspective view of the recording head 1 in a state where respective components have been assembled onto the recording head 1, and FIG. 2C is a view taken along an arrow A in FIG. 2B. The recording head 1 includes a plurality of circulation units 54 and a housing 70 in which the circulation units 54 are housed. The recording head 1 includes circulation units 54a to 54d, each of which corresponds to ink of each color, and the respective circulation units 54a to 54d are connected to the housing 70. As a method of connecting the circulation units 54a to 54d and the housing 70 to each other, fastening by screws with a sealing member (not illustrated) sandwiched in-between or connecting by welding may be adopted. The sealing member and each circulation unit 54 may be separate bodies or may be integrally molded.

The housing 70 is provided with a joint surface 111 for accepting ink from a recording apparatus main body. The joint surface 111 is provided with a joint 111a which communicates with the circulation unit 54a, a joint 111b which communicates with the circulation unit 54b, a joint 111c which communicates with the circulation unit 54c, and a joint 111d which communicates with the circulation unit 54d. Note that the joint surface 111 may be a surface having been integrally formed with the housing 70 or a separate member that only forms the joint surface 111 may be provided. When mounting the recording head 1 to the recording apparatus main body, a supply tube (not illustrated) corresponding to each ink is connected to each of the joints 111a to 111d from a side of the recording apparatus main body. Each ink supplied from the supply tube is supplied to each of the circulation units 54a to 54d via the joints 111a to 111d of the housing 70.

A recording element unit 20 is connected to a bottom surface 113 of the housing 70. The recording element unit 20 is constituted of a supporting member 21, a connecting substrate 22, and a discharge module 300. By connecting the supporting member 21 mounted with the discharge module 300 to the bottom surface 113, the discharge module 300 including discharge ports of ink and the like is connected to the circulation units 54a to 54d. Details of the discharge module 300 and the recording element unit 20 will be provided later. Ink supplied to the circulation units 54a to 54d is supplied to the recording element unit 20 via the housing 70. As a method of connecting the supporting member 21 and the housing 70 to each other, adhesion using an adhesive or fixing by fastening screws while sandwiching a sealing member between the supporting member 21 and the housing 70 may be adopted. The discharge module 300 and the supporting member 21 are bonded to each other by an adhesive.

A surface of the housing 70 on an opposite side to the joint surface 111 is a contact surface 114 and an electric substrate 23 which receives electric signals from the recording apparatus main body is connected to the contact surface 114. Furthermore, the recording head 1 includes the connecting substrate 22 for sending electric signals to the discharge module 300 from the electric substrate 23. The connecting substrate 22 is electrically connected to each of the electric substrate 23 and the discharge module 300. The connection between the electric substrate 23 and the housing 70 may be performed by fixing by swaging or using an adhesive or fixing using a double-sided tape.

The connecting substrate 22 is fixed to the supporting member 21 by bonding. The connecting substrate 22 is configured so as to include a surface to be connected to the supporting member 21 and a surface positioned on a side of the contact surface 114 of the housing 70. The side of the supporting member 21 of the connecting substrate 22 is electrically connected to the discharge module 300 and the side of the contact surface 114 of the connecting substrate 22 is electrically connected to the electric substrate 23. The connection between the connecting substrate 22 and the discharge module 300 may be performed by wire bonding or flying lead bonding. The connection between the connecting substrate 22 and the electric substrate 23 may also be performed by wire bonding or ACF compression bonding.

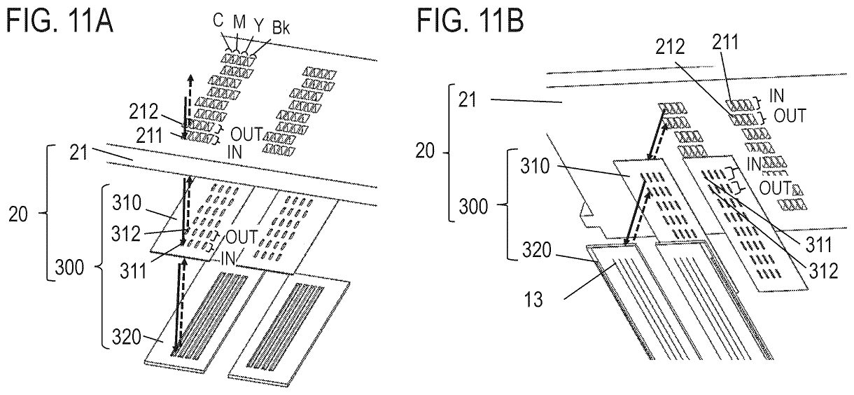

The discharge module 300 includes a recording element substrate 320 (refer to FIG. 11A and the like) and an energy generation element which is provided on one surface of the recording element substrate 320 and which generates energy for discharging liquid. The recording element substrate 320 is a substrate made of silicon with a thickness of 0.5 to 1 mm. In the first embodiment, a plurality of thermal resistive elements are used as the energy generation element and electric wiring for supplying power to each thermal resistive element is formed on the recording element substrate 320 by a film deposition technique.

A plurality of ink flow paths corresponding to the thermal resistive elements and a plurality of discharge ports which discharge ink are formed on the recording element substrate 320 by a photolithographic technique. A common supply flow path 18 and a supply port 323 which supply ink to a plurality of pressure chambers 12 and a common collecting flow path 19 and a collecting port 324 which collect ink from the pressure chambers 12 are formed on a rear surface of the recording element substrate 320. Note that the expressions of “supply” and “collecting” of ink as used herein refers to supply and collect during ink circulation in a forward direction to be described later, and during ink circulation in a backward direction, ink is to be supplied from the collecting port 324 and collected from the supply port 323. Configurations thereof will be described in detail later.

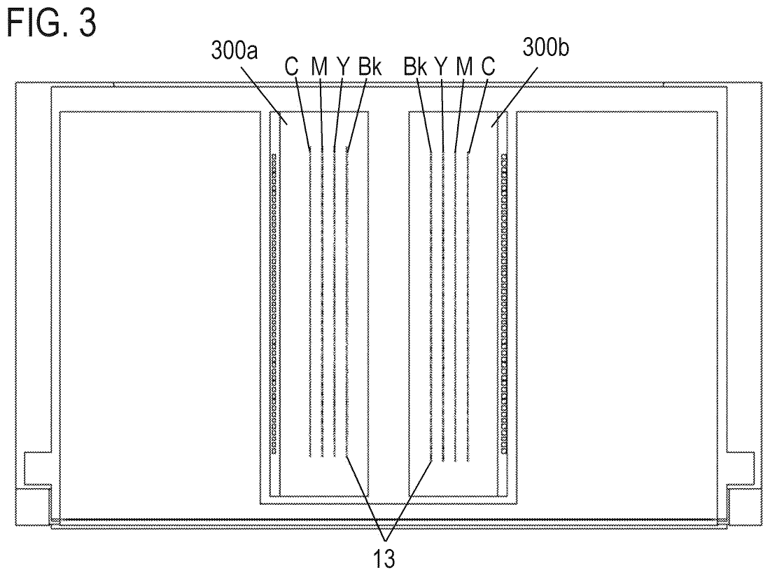

The recording head 1 according to the first embodiment is mounted with two discharge modules 300a and 300b. FIG. 3 is a lower view when the recording head 1 is viewed from a downstream side in a discharge direction of ink. Each of the discharge modules 300a and 300b includes a discharge port array which is constructed by lining up a plurality of the discharge ports 13 in a row and which corresponds to ink of each color.

In the scanning recording head 1, since ink is discharged in a positional order of colors of discharge port arrays arranged with respect to the main scanning direction, orders of discharge differ between reciprocal directions during scanning. When using the recording head 1 configured in this manner, in order to reduce print non-uniformity due to the difference in orders of discharge between reciprocal directions, measures such as printing each row in a reciprocating manner may be adopted. However, such multi-pass printing may result in a decline in print speed. Therefore, in the scanning recording head 1, discharge port arrays of the same colors are arranged by being lined up in both directions as shown in FIG. 3. In other words, the recording head 1 is mounted with two discharge modules 300 so that an order of colors of the discharge port arrays in the main scanning direction is expressed as, for example, CMYKKYMC. Note that the color order is not limited thereto as long as a bi-directional arrangement is realized. Adopting such a configuration enables the scanning recording head 1 to reduce the number of scans during printing and to increase the print speed. Note that only one discharge module 300 may be provided in the case of a bi-directional arrangement of the same color as described above.

### Constituent Elements of Circulation Unit

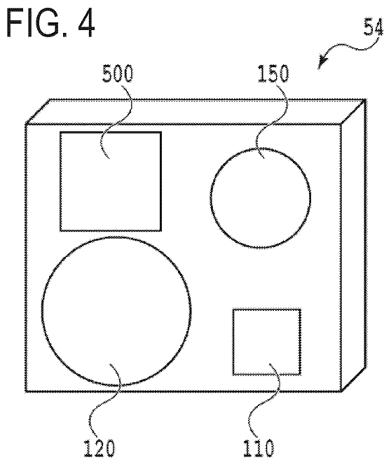

A configuration of the circulation unit 54 of the recording head 1 will now be described in greater detail. FIG. 4 is a schematic perspective view showing a schematic configuration of the circulation unit 54 according to the first embodiment. FIG. 4 shows one circulation unit 54 corresponding to one type of ink. The circulation unit 54 includes a circulation pump 500, a filter 110, first pressure adjusting means 120, and second pressure adjusting means 150. The circulation pump 500, the first pressure adjusting means 120, and the second pressure adjusting means 150 are connected by each flow path and constitute a circulatory flow path which performs supply and collecting of ink with respect to the discharge modules 300 in the recording head 1. FIG. 4 represents an example of constituent elements of the circulation unit 54 and is not intended to limit relative positions of the constituent elements to those illustrated.

### Ink Circulation in Recording Head

A configuration example for causing ink to be circulated in the recording head 1 will be described. Note that the configuration of the circulatory portion of ink described below is merely an example and applications of the present invention are not limited to such configurations.

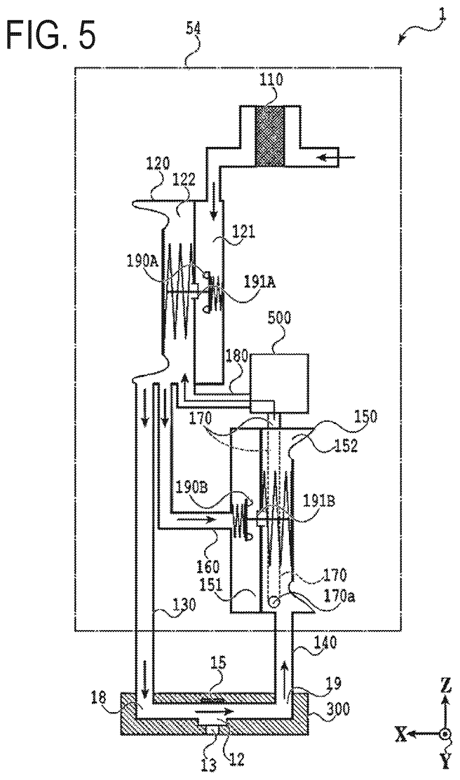

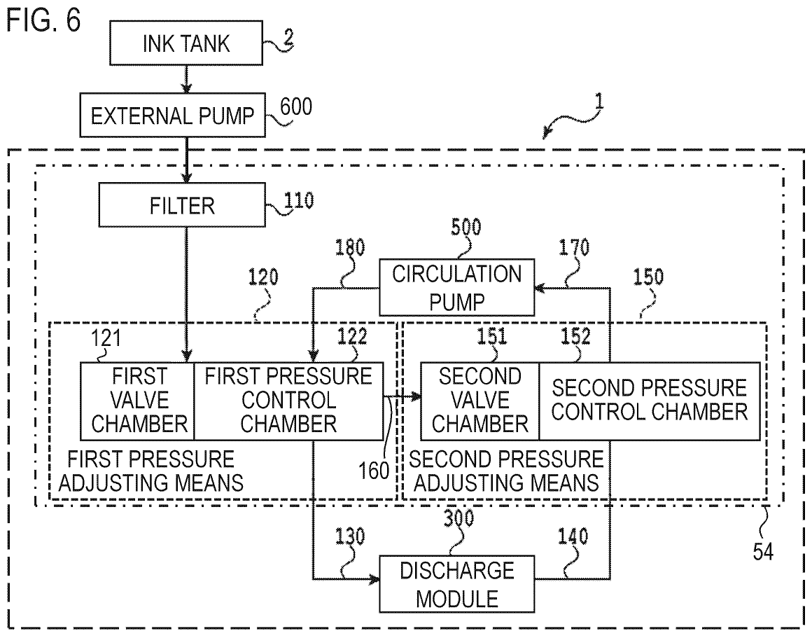

FIG. 5 is an explanatory diagram of an ink flow path of one type (one color) constructed in the recording head 1 and schematically shows a cross section of the recording head 1. In order to describe the ink flow path in a clearer manner, the relative positions of the respective components (the first pressure adjusting means 120, the second pressure adjusting means 150, the circulation pump 500, and the like) in FIG. 5 are shown in a simplified state. Therefore, the relative positions of the respective components may differ from configurations and the like shown in other drawings. FIG. 6 is a block diagram schematically showing the ink flow path shown in FIG. 5. The ink flow path of the recording head 1 according to the first embodiment is constituted of a flow path inside the circulation unit 54 and a flow path inside the discharge module 300.

The ink flow path is mainly constituted of an inflow flow path and a circulatory flow path. The inflow flow path is a flow path into which ink flows from the ink tank 2 provided outside of the recording head 1 and which is formed inside the circulation unit 54. The circulatory flow path is a flow path through which ink flows in a circulating manner and which is formed so as to straddle the inside of the circulation unit 54 and the inside of the discharge module 300. The circulatory flow path is constituted of the first pressure adjusting means 120, the second pressure adjusting means 150, the circulation pump 500, the pressure chamber 12 being an individual liquid chamber, and the like.

The first pressure adjusting means 120 includes a first valve chamber 121 and a first pressure control chamber 122. The second pressure adjusting means 150 includes a second valve chamber 151 and a second pressure control chamber 152. The first pressure adjusting means 120 is configured so that control pressure thereof is relatively higher than that of the second pressure adjusting means 150. In the first embodiment, circulation of ink in a certain pressure range is realized in the circulatory flow path by using two pressure adjusting means, namely, the first pressure adjusting means 120 and the second pressure adjusting means 150. In addition, the circulation unit 54 is configured so that ink flows through the pressure chamber 12 (discharge element 15) at a flow rate in accordance with a pressure difference between the first pressure adjusting means 120 and the second pressure adjusting means 150. Hereinafter, the circulatory flow path in the recording head 1 and a flow of ink in the circulatory flow path will be described with reference to FIGS. 5 and 6. Arrows in each drawing depict a direction in which ink flows.

A connection state of each constituent element of the recording head 1 which constitutes the ink flow path will be described. The external pump 600 which sends the ink housed in the ink tank 2 provided outside the recording head 1 to the recording head 1 is connected to the circulation unit 54 via the ink supply tube 59 (refer to FIGS. 1A and 1B). The ink is supplied to the inflow flow path of the ink flow path of the circulation unit 54 from the ink tank 2 via the external pump 600. The inflow flow path is connected to the first pressure adjusting means 120 which constitutes the circulatory flow path of ink and the filter 110 is provided inside the inflow flow path. By providing the filter 110 inside the inflow flow path, foreign objects and the like can be prevented from penetrating into the circulatory flow path.

The ink supply path of the inflow flow path positioned on a downstream side in an ink inflow direction with respect to the filter 110 is connected to the first valve chamber 121 of the first pressure adjusting means 120. The first valve chamber 121 is communicated with the first pressure control chamber 122 via a communication port 191A that can be opened and closed by a valve 190A.

The first pressure control chamber 122 is connected to a supply flow path 130, a bypass flow path 160, and a pump outlet flow path 180 of the circulation pump 500. The supply flow path 130 is connected to the common supply flow path 18 in the discharge module 300 via the ink supply port provided in the discharge module 300.

The bypass flow path 160 is connected to the second valve chamber 151 provided in the second pressure adjusting means 150. The second valve chamber 151 is communicated with the second pressure control chamber 152 via a communication port 191B that can be opened and closed by a valve 190B. In other words, one end of the bypass flow path 160 is connected to the first pressure control chamber 122 of the first pressure adjusting means 120 and another end of the bypass flow path 160 is connected to the second valve chamber 151 of the second pressure adjusting means 150. Note that the circulatory path of ink shown in FIGS. 5 and 6 is an example of a configuration to which the present invention is applied and the circulatory path of ink need not necessarily be configured in exactly the same manner when applying the present invention. For example, one end of the bypass flow path 160 may be connected to the supply flow path 130 and the other end of the bypass flow path 160 may be connected to the second valve chamber 151.

The second pressure control chamber 152 is connected to a collecting flow path 140. The collecting flow path 140 is connected to the common collecting flow path 19 in the discharge module 300 via the ink collecting port provided in the discharge module 300. Furthermore, the second pressure control chamber 152 is connected to the circulation pump 500 via a pump inlet flow path 170. FIG. 5 shows an inflow port 170a of the pump inlet flow path 170.

As described above, in the first embodiment, the ink flow path of the recording head 1 is constituted of the circulation unit 54 and the discharge module 300. In summary, the supply flow path 130 communicates the first pressure control chamber 122 and the common supply flow path 18 with each other, the collecting flow path 140 communicates the common collecting flow path 19 and the second pressure control chamber 152 with each other, and the bypass flow path 160 communicates the first pressure control chamber 122 and the second valve chamber 151 with each other. In addition, the pump inlet flow path 170 communicates the second pressure control chamber 152 and the circulation pump 500 with each other and the pump outlet flow path 180 communicates the circulation pump 500 and the first pressure control chamber 122 with each other.

### Ink Flow in Circulatory Portion

Next, a flow of ink in the circulatory portion according to the configuration example described above will be described. The ink housed in the ink tank 2 is pressurized by the external pump 600 provided in the liquid discharge apparatus 50 and supplied to the circulation unit 54 of the recording head 1 as an ink flow under positive pressure.

The ink supplied to the circulation unit 54 passes through the filter 110 to have foreign objects such as dust and air bubbles removed therefrom and subsequently flows into the first valve chamber 121 provided in the first pressure adjusting means 120. While pressure of the ink drops due to pressure loss when the ink passes through the filter 110, the pressure of the ink at this stage is in a state of positive pressure.

Subsequently, when the valve 190A is open, the ink having flowed into the first valve chamber 121 passes through the communication port 191A and flows into the first pressure control chamber 122. Due to pressure loss when passing through the communication port 191A, the ink having flowed into the first pressure control chamber 122 changes from positive pressure to negative pressure.

Next, a flow of ink in the circulatory path will be described. The circulation pump 500 operates so as to send out ink sucked from the pump inlet flow path 170 on the upstream side in the circulation direction of the liquid to the pump outlet flow path 180 on the downstream side. Therefore, due to the circulation pump 500 being driven, the ink supplied to the first pressure control chamber 122 flows into the supply flow path 130 and the bypass flow path 160 together with the ink fed from the pump outlet flow path 180.

Note that the circulation pump 500 according to the first embodiment is a piezoelectric diaphragm pump capable of feeding liquid using a piezoelectric element affixed to a diaphragm as a driving source. The piezoelectric diaphragm pump is a pump of which a capacity in a pump chamber changes by inputting a drive voltage to the piezoelectric element and which feeds a liquid by having two check valves alternately operate due to a pressure fluctuation.

The ink flowed into the supply flow path 130 flows into the pressure chamber 12 via the common supply flow path 18 from the ink supply port of the discharge module 300 and a part of the ink is discharged from the discharge port 13 due to driving (heat generation) of the discharge element 15. The remaining ink that had not been discharged flows in the pressure chamber 12, passes through the common collecting flow path 19, and subsequently flows into the collecting flow path 140 that is connected to the discharge module 300. The ink flowed into the collecting flow path 140 flows into the second pressure control chamber 152 of the second pressure adjusting means 150.

On the other hand, the ink having flowed into the bypass flow path 160 from the first pressure control chamber 122 flows into the second valve chamber 151 and subsequently passes through the communication port 191B and flows into the second pressure control chamber 152.

The ink having flowed into the second pressure control chamber 152 via the bypass flow path 160 and the ink having been collected from the collecting flow path 140 are sucked into the circulation pump 500 via the pump inlet flow path 170 due to driving of the circulation pump 500. In addition, the ink sucked into the circulation pump 500 is sent to the pump outlet flow path 180 and once again flows into the first pressure control chamber 122.

Subsequently, the ink that flows into the second pressure control chamber 152 via the supply flow path 130 and the discharge module 300 from the first pressure control chamber 122 and the ink that flows into the second pressure control chamber 152 via the bypass flow path 160 flow into the circulation pump 500. In addition, the ink is fed from the circulation pump 500 to the first pressure control chamber 122. The circulation of ink in the circulatory path is to be performed in this manner.

As described above, in the present embodiment, a liquid such as ink can be caused to circulate along a circulatory path formed in the recording head 1 using the circulation pump 500. Therefore, thickening of ink or a deposition of sedimentary components of ink such as color materials in the discharge module 300 can be suppressed and flowability of the ink in the discharge module 300 and discharge characteristics at the discharge ports 13 can be kept in favorable states.

In addition, since the circulatory path in the present embodiment adopts a configuration in which the circulatory path is contained in the recording head 1, a circulatory path length can be significantly shortened as compared to a case where ink is circulated between the ink tank 2 provided outside the recording head 1 and the recording head 1. Therefore, ink can be circulated using a small pump.

Furthermore, the connecting flow path between the recording head 1 and the ink tank 2 is constituted solely of a flow path which supplies ink from the ink tank 2 to the recording head 1. In other words, a configuration is adopted which does not require a flow path for collecting ink from the recording head 1 to the ink tank 2. As a result, a tube for supplying ink need only be provided in order to connect the ink tank 2 and the recording head 1 with each other and a tube for collecting ink need not be provided. Therefore, the inside of the liquid discharge apparatus 50 can be configured in a simple manner with a reduced number of tubes and downsizing of the entire apparatus can be realized. Furthermore, a reduction in the number of tubes enables a pressure fluctuation of ink attributable to swinging of tubes that accompany main scanning of the recording head 1 to be reduced. In addition, swinging of tubes during main scanning of the recording head 1 becomes a drive load on the carriage motor 303 which drives the carriage 53. Therefore, by reducing the number of tubes, the drive load on the carriage motor 303 can be reduced and a main scanning mechanism including the carriage motor 303 can be simplified. Furthermore, since there is no longer a need to collect ink from the liquid discharge head to the ink tank 2, the external pump 600 can also be downsized. In this manner, according to the present embodiment, downsizing and cost reduction of the liquid discharge apparatus 50 can be realized.

### Pressure Adjusting Means

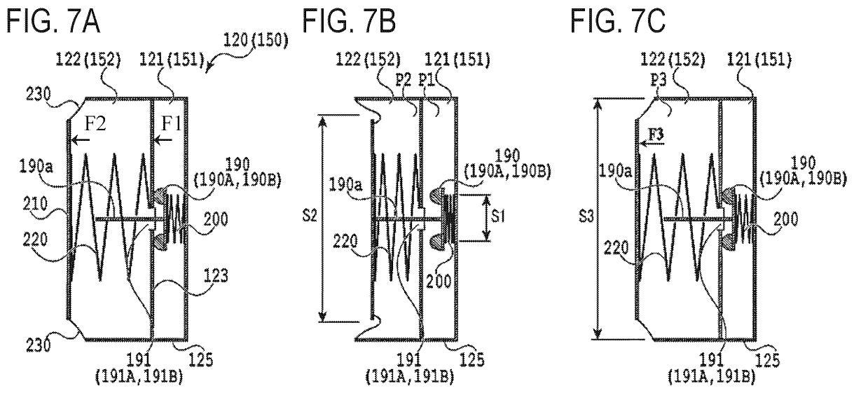

Next, configurations and workings of the pressure adjusting means (the first pressure adjusting means 120 and the second pressure adjusting means 150) which are built into the recording head 1 described above will be described in greater detail with reference to FIGS. 7A to 7C. FIGS. 7A to 7C are diagrams showing configuration examples of the pressure adjusting means of the recording head 1 according to the first embodiment. Note that the first pressure adjusting means 120 and the second pressure adjusting means 150 are configured substantially the same. Therefore, hereinafter, the first pressure adjusting means 120 will be described as an example and the description of the second pressure adjusting means 150 will be limited to notating reference signs of portions corresponding to the first pressure adjusting means 120 in FIGS. 7A to 7C. In the case of the second pressure adjusting means 150, the first valve chamber 121 described below shall be replaced with the second valve chamber 151 and the first pressure control chamber 122 shall be replaced with the second pressure control chamber 152.

The first pressure adjusting means 120 includes the first valve chamber 121 and the first pressure control chamber 122 formed inside a cylindrical housing 125. The first valve chamber 121 and the first pressure control chamber 122 are separated by a bulkhead 123 provided inside the cylindrical housing 125. However, the first valve chamber 121 is communicated with the first pressure control chamber 122 via a communication port 191 formed in the bulkhead 123. The first valve chamber 121 is provided with a valve 190 which switches between communication and shut-off between the first valve chamber 121 and the first pressure control chamber 122 in the communication port 191. The valve 190 is held by a valve spring 200 at a position where the valve 190 opposes the communication port 191 and is configured to be capable of coming into close contact with the bulkhead 123 due to a biasing force of the valve spring 200. The distribution of ink in the communication port 191 is shut off when the valve 190 comes into close contact with the bulkhead 123. In order to increase a degree of close contact with the bulkhead 123, a portion of the valve 190 which comes into contact with the bulkhead 123 is preferably formed of an elastic member. In addition, a valve shaft 190a to be inserted into the communication port 191 is provided so as to protrude from a central portion of the valve 190. When the valve shaft 190a is pressed against the biasing force of the valve spring 200, the valve 190 separates from the bulkhead 123 and enables ink to be distributed through the communication port 191. Hereinafter, a state where the distribution of ink through the communication port 191 is shut off by the valve 190 will be referred to as a “closed state” and the state where the distribution of ink through the communication port 191 is enabled will be referred to as an “open state”.

An opening of the cylindrical housing 125 is closed by a flexible member 230 and a pressure plate 210. The first pressure control chamber 122 is formed by the flexible member 230, the pressure plate 210, a peripheral wall of the housing 125, and the bulkhead 123. The pressure plate 210 is configured so as to be displaceable accompanying a displacement of the flexible member 230. While materials of the pressure plate 210 and the flexible member 230 are not particularly limited, for example, the pressure plate 210 can be constructed of a resin molded component and the flexible member 230 may be constructed of a resin film. In this case, the pressure plate 210 can be fixed to the flexible member 230 by heat sealing.

A pressure adjustment spring 220 (biasing member) is provided between the pressure plate 210 and the bulkhead 123. Due to the biasing force of the pressure adjustment spring 220, the pressure plate 210 and the flexible member 230 are biased in a direction where an inner capacity of the first pressure control chamber 122 increases as shown in FIG. 7A. In addition, when pressure inside the first pressure control chamber 122 decreases, the pressure plate 210 and the flexible member 230 are displaced in a direction where an inner capacity of the first pressure control chamber 122 decreases against pressure of the pressure adjustment spring 220. Furthermore, when the inner capacity of the first pressure control chamber 122 decreases to a certain amount, the pressure plate 210 abuts the valve shaft 190a of the valve 190. Subsequently, when the inner capacity of the first pressure control chamber 122 further decreases, the valve 190 moves together with the valve shaft 190a against the biasing force of the valve spring 200 and separates from the bulkhead 123. Accordingly, the communication port 191 changes to an open state (the state shown in FIG. 7B).

In the present embodiment, connections in the circulatory path are configured so that the pressure in the first valve chamber 121 when the communication port 191 changes to the open state is higher than the pressure of the first pressure control chamber 122. Accordingly, when the communication port 191 changes to the open state, ink flows into the first pressure control chamber 122 from the first valve chamber 121. Due to the inflow of ink, the flexible member 230 and the pressure plate 210 are displaced in a direction where the inner capacity of the first pressure control chamber 122 increases. As a result, the pressure plate 210 separates from the valve shaft 190a of the valve 190, the valve 190 comes into close contact with the bulkhead 123 due to the biasing force of the valve spring 200, and the communication port 191 changes to the closed state (the state in FIG. 7C).

In this manner, in the first pressure adjusting means 120 according to the present embodiment, when the pressure in the first pressure control chamber 122 decreases to or below certain pressure (for example, when negative pressure increases), ink flows in from the first valve chamber 121 via the communication port 191. Accordingly, the first pressure control chamber 122 is configured so that pressure thereof does not drop any further. As a result, the first pressure control chamber 122 is controlled so that pressure is kept within a certain range.

Next, pressure in the first pressure control chamber 122 will be described in greater detail.

A state where the flexible member 230 and the pressure plate 210 are displaced in accordance with the pressure in the first pressure control chamber 122 as described above, the pressure plate 210 abuts the valve shaft 190a, and the communication port 191 changes to the open state (the state in FIG. 7B) will be considered. At this point, a relationship among forces acting on the pressure plate 210 is represented by Expression 1 below.

$$P 2 \times S 2 + F 2 + ( P 1 - P 2 ) \times S 1 + F 1 = 0 \qquad Expression 1$$

Furthermore, Expression 1 may be organized with respect to P2 as

$$P 2 = - ( F 1 + F 2 + P 1 \times S 1 ) / ( S 2 - S 1 ) \qquad Expression 2$$

P1: pressure (gauge pressure) in first valve chamber 121
P2: pressure (gauge pressure) in first pressure control chamber 122
F1: spring force of valve spring 200
F2: spring force of pressure adjustment spring 220
S1: pressure-receiving area of valve 190
S2: pressure-receiving area of pressure plate 210

In this case, with the spring force F1 of the valve spring 200 and the spring force F2 of the pressure adjustment spring 220, a direction in which the valve 190 and the pressure plate 210 are pressed is considered positive (leftward in FIGS. 7A to 7C). In addition, the pressure P1 of the first valve chamber 121 and the pressure P2 of the first pressure control chamber 122 are configured so that P1 satisfies a relationship expressed as P1≥P2.

The pressure P2 of the first pressure control chamber 122 when the communication port 191 assumes an open state is determined by Expression 2, and when the communication port 191 assumes the open state, ink flows into the first pressure control chamber 122 from the first valve chamber 121 due to adopting the relationship expressed as P1≥P2. As a result, the pressure P2 of the first pressure control chamber 122 does not drop any further and P2 is controlled to within a certain pressure range.

On the other hand, as shown in FIG. 7C, a relationship among forces that act on the pressure plate 210 when the pressure plate 210 and the valve shaft 190a change to a non-abutting state and the communication port 191 assumes a closed state is as represented by Expression 3.

$$P 3 \times S 3 + F 3 = 0 \qquad Expression 3$$

Expression 3 may be organized with respect to P3 as

$$P 3 = - F 3 / S 3 \qquad Expression 4$$

F3: spring force of pressure adjustment spring 220 when pressure plate 210 and valve shaft 190a are in non-abutting state
P3: pressure (gauge pressure) in first pressure control chamber 122 when pressure plate 210 and valve shaft 190a are in non-abutting state
S3: pressure-receiving area of pressure plate 210 when pressure plate 210 and valve shaft 190a are in non-abutting state

In this case, FIG. 7C represents a state where the pressure plate 210 and the flexible member 230 have been displaced in a rightward direction in the drawing all the way to a displaceable limit. The pressure P3 of the first pressure control chamber 122, the spring force F3 of the pressure adjustment spring 220, and the pressure-receiving area S3 of the pressure plate 210 change according to an amount of displacement when the pressure plate 210 and the flexible member 230 are displaced to the state shown in FIG. 7C. Specifically, when the pressure plate 210 and the flexible member 230 are rightward in the drawing as compared to FIG. 7C, the pressure-receiving area S3 of the pressure plate 210 decreases and the spring force F3 of the pressure adjustment spring 220 increases. As a result, the pressure P3 of the first pressure control chamber 122 decreases according to the relationship represented by Expression 4. Therefore, according to Expression 2 and Expression 4, the pressure of the first pressure control chamber 122 gradually rises (in other words, negative pressure decreases and assumes a value approaching a positive pressure side) during a transition from the state shown in FIG. 7B to the state shown in FIG. 7C. In other words, the pressure of the first pressure control chamber 122 gradually rises as the pressure plate 210 and the flexible member 230 are gradually displaced leftward from a state where the communication port 191 is in the open state and until the inner capacity of the first pressure control chamber 122 finally reaches a displaceable limit. In other words, negative pressure decreases.

### Circulation Pump

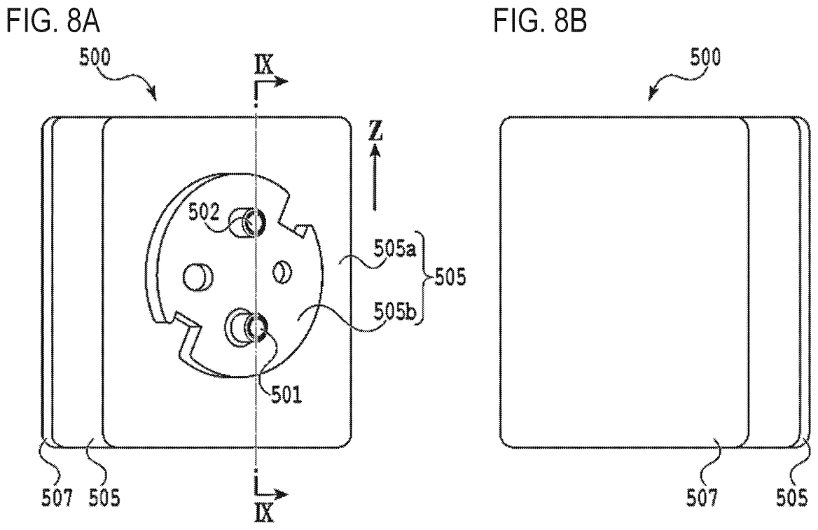

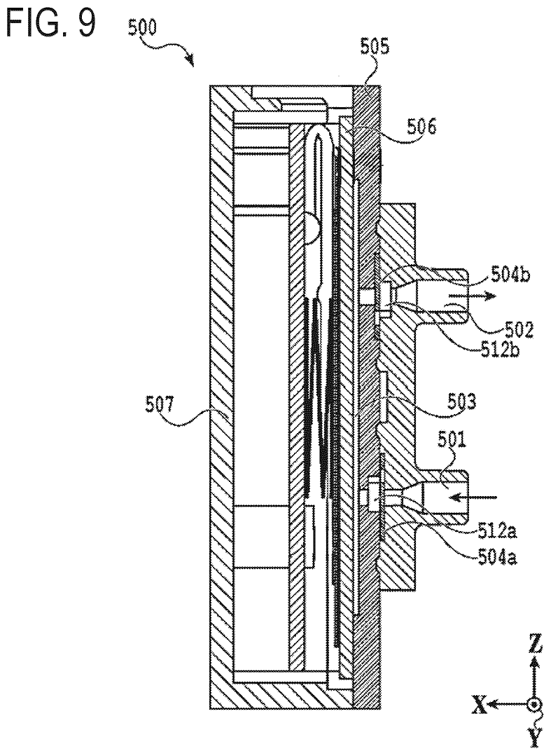

Next, configurations and workings of the circulation pump 500 which is built into the recording head 1 described above will be described in greater detail with reference to FIGS. 8A and 8B and FIG. 9.

FIGS. 8A and 8B are external perspective views of the circulation pump 500. FIG. 8A is an external perspective view showing a front surface side of the circulation pump 500 and FIG. 8B is an external perspective view showing a rear surface side of the circulation pump 500. An outer shell of the circulation pump 500 is constituted of a pump housing 505 and a cover 507 fixed to the pump housing 505.

The pump housing 505 is constituted by a housing portion main body 505a and a flow path connecting member 505b which is bonded and fixed to an outer surface of the housing portion main body 505a. Pairs of through-holes communicated with each other are provided at two different positions of each of the housing portion main body 505a and the flow path connecting member 505b. The pair of through-holes provided at one of the positions forms a pump supply hole 501 and the pair of through-holes provided at the other position forms a pump discharge hole 502.

The pump supply hole 501 is connected to the pump inlet flow path 170 connected to the second pressure control chamber 152 and the pump discharge hole 502 is connected to the pump outlet flow path 180 connected to the first pressure control chamber 122. Ink supplied from the pump supply hole 501 passes through a pump chamber 503 (refer to FIG. 9) to be described later and is discharged from the pump discharge hole 502.

FIG. 9 is a sectional view of the circulation pump 500 taken along line IX-IX in FIG. 8A. A diaphragm 506 is bonded to an inner surface of the pump housing 505 and the pump chamber 503 is formed in a depressed portion formed on inner surfaces of the diaphragm 506 and the pump housing 505. The pump chamber 503 is communicated with the pump supply hole 501 and the pump discharge hole 502 formed in the pump housing 505. In addition, a check valve 504a is provided in an intermediate portion of the pump supply hole 501 and a check valve 504b is provided in an intermediate portion of the pump discharge hole 502. Specifically, the check valve 504a is arranged so that a part thereof can move leftward in the drawing in a space 512a formed in the intermediate portion of the pump supply hole 501. In addition, the check valve 504b is arranged so that a part thereof can move rightward in the drawing in a space 512b formed in the intermediate portion of the pump discharge hole 502.

When the pump chamber 503 is depressurized due to the diaphragm 506 being displaced and the capacity of the pump chamber 503 being increased, the check valve 504a separates from an opening of the pump supply hole 501 inside the space 512a (in other words, moves leftward in the drawing). Due to the check valve 504a separating from the opening of the pump supply hole 501 inside the space 512a, the open state is created where distribution of ink in the pump supply hole 501 is enabled. In addition, when the pump chamber 503 is pressurized due to the diaphragm 506 being displaced and the capacity of the pump chamber 503 being reduced, the check valve 504a comes into close contact with a wall surface in a periphery of the opening of the pump supply hole 501. As a result, the closed state is created where the distribution of ink in the pump supply hole 501 is shut off.

On the other hand, when the pump chamber 503 is depressurized, the check valve 504b comes into close contact with a wall surface in a periphery of the opening of the pump housing 505 and creates the closed state where the distribution of ink in the pump discharge hole 502 is shut off. In addition, when the pump chamber 503 is pressurized, the check valve 504b separates from the opening of the pump housing 505 and moves to a side of the space 512b ((in other words, moves rightward in the drawing) and distribution of ink in the pump discharge hole 502 is enabled.

Note that a material of each of the check valves 504a and 504b need only be deformable in response to pressure inside the pump chamber 503 and, for example, the check valves 504a and 504b can be formed using an elastic member such as EPDM or an elastomer a film or a thin plate of polypropylene or the like. However, the material of the check valves 504a and 504b is not limited to the above.

As described above, the pump chamber 503 is formed by bonding the pump housing 505 and the diaphragm 506 to each other. Therefore, pressure inside the pump chamber 503 changes when the diaphragm 506 deforms. For example, when the diaphragm 506 is displaced toward the side of the pump housing 505 (displaced rightward in the drawing) and the capacity of the pump chamber 503 decreases, the pressure inside the pump chamber 503 rises. Accordingly, the check valve 504b arranged so as to oppose the pump discharge hole 502 changes to the open state and ink in the pump chamber 503 is discharged. At this point, since the check valve 504a arranged so as to oppose the pump supply hole 501 comes into close contact with the wall surface in the periphery of the pump supply hole 501, a counterflow of ink from the pump chamber 503 into the pump supply hole 501 is suppressed.

In addition, conversely, when the diaphragm 506 is displaced in a direction in which the pump chamber 503 expands, the pressure in the pump chamber 503 decreases. Accordingly, the check valve 504a arranged so as to oppose the pump supply hole 501 changes to the open state and ink is supplied to the pump chamber 503. At this point, the check valve 504b arranged in the pump discharge hole 502 comes into close contact with the wall surface in the periphery of an opening formed in the pump housing 505 and blocks the opening. Therefore, a counterflow of ink from the pump discharge hole 502 to the pump chamber 503 is suppressed.

In this manner, in the circulation pump 500, suction and discharge of ink are performed due to the deformation of the diaphragm 506 causing the pressure inside the pump chamber 503 to change. In doing so, when bubbles enter the pump chamber 503, a pressure change in the pump chamber 503 decreases due to expansion and contraction of the bubbles even if the diaphragm 506 is displaced and an amount of fed liquid is reduced. In consideration thereof, the pump chamber 503 is arranged parallel to gravity in order to facilitate collecting of bubbles having entered the pump chamber 503 to an upper part of the pump chamber 503 and, at the same time, the pump discharge hole 502 is arranged above a center of the pump chamber 503. Accordingly, discharge characteristics of bubbles inside the pump can be improved and a flow rate can be stabilized.

### Ink Flow During Ink Circulation

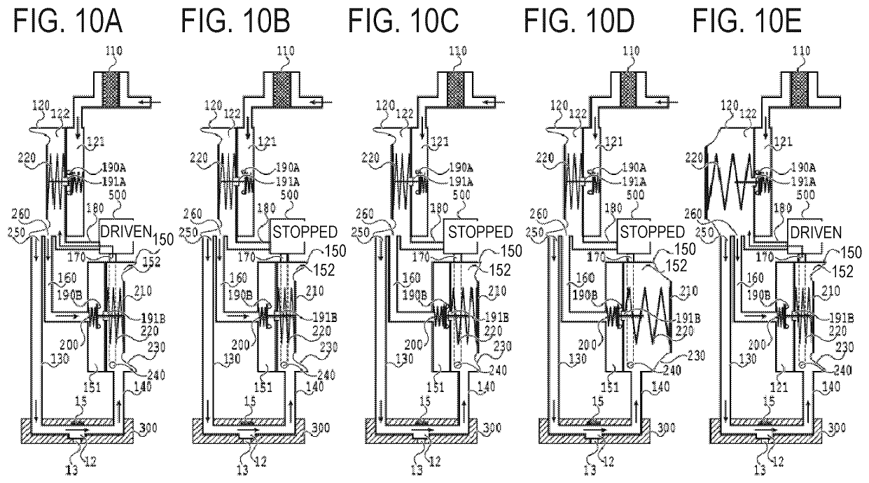

The circulation of ink performed in the recording head 1 will now be described in greater detail with reference to FIGS. 10A to 10E. FIGS. 10A to 10E are explanatory diagrams of a flow of ink in the recording head 1. In order to describe the ink circulatory path in a clearer manner, the relative positions of the respective components (the first pressure adjusting means 120, the second pressure adjusting means 150, the circulation pump 500, and the like) in FIGS. 10A to 10E are shown in a simplified state. Therefore, the relative positions of the respective components may differ from configurations and the like shown in other drawings.

FIG. 10A schematically shows a flow of ink when performing a recording operation in which ink is discharged from the discharge port 13 and recording is performed. Arrows in the drawing depict a flow of ink. In the first embodiment, when performing a recording operation, driving of both the external pump 600 and the circulation pump 500 is started. Note that the external pump 600 and the circulation pump 500 may be driven regardless of a recording operation. In addition, driving of the external pump 600 and driving of the circulation pump 500 may be performed in an interlinked manner or each of the external pump 600 and the circulation pump 500 may be independently driven.

During a recording operation, the circulation pump 500 is in an ON state (driven state) and ink having flowed out from the first pressure control chamber 122 flows into the supply flow path 130 and the bypass flow path 160. The ink having flowed into the supply flow path 130 passes through the discharge module 300, flows into the collecting flow path 140, and is subsequently supplied to the second pressure control chamber 152.

On the other hand, the ink having flowed into the bypass flow path 160 from the first pressure control chamber 122 flows into the second pressure control chamber 152 via the second valve chamber 151. The ink having flowed into the second pressure control chamber 152 passes through the pump inlet flow path 170, the circulation pump 500, and the pump outlet flow path 180, and subsequently once again flows into the first pressure control chamber 122. At this point, control pressure due to the first valve chamber 121 is set higher than control pressure of the first pressure control chamber 122 based on the relation represented by Expression 2 described above. Therefore, the ink inside the first pressure control chamber 122 is supplied to the discharge module 300 once again via the supply flow path 130 instead of flowing into the first valve chamber 121. The ink having flowed into the discharge module 300 passes the collecting flow path 140, the second pressure control chamber 152, the pump inlet flow path 170, the circulation pump 500, and the pump outlet flow path 180, and subsequently once again flows into the first pressure control chamber 122. Accordingly, ink circulation which is contained inside the recording head 1 is performed.

In the ink circulation described above, a circulation amount (flow rate) of ink inside the discharge module 300 is determined by differential pressure between the control pressure of the first pressure control chamber 122 and the control pressure of the second pressure control chamber 152. In addition, the differential pressure is set so as to realize a circulation amount that enables thickening of ink in a vicinity of a discharge port in the discharge module 300 to be suppressed.

Furthermore, ink corresponding to an amount consumed by recording is supplied from the ink tank 2 to the first pressure control chamber 122 via the filter 110 and the first valve chamber 121. A mechanism by which consumed ink is supplied will now be described in detail. Due to a decrease in ink from inside the circulatory path by exactly the amount of ink consumed by the recording, the pressure inside the first pressure control chamber drops and, consequently, the ink inside the first pressure control chamber 122 also decreases. With the decrease in ink in the first pressure control chamber 122, an inner capacity of the first pressure control chamber 122 decreases. Due to the decrease in the inner capacity of the first pressure control chamber 122, the communication port 191A changes to the open state and ink is supplied from the first valve chamber 121 to the first pressure control chamber 122.

The supplied ink is subjected to pressure loss when passing through the communication port 191A from the first valve chamber 121 and, by flowing into the first pressure control chamber 122, ink at positive pressure is switched to a negative-pressure state. In addition, due to the ink flowing into the first pressure control chamber 122 from the first valve chamber 121, a rise in the pressure in the first pressure control chamber 122 causes the capacity of the first pressure control chamber 122 to increase and the communication port 191A changes to the closed state. In this manner, the communication port 191A repetitively assumes the open state and the closed state in accordance with the consumption of ink. In addition, when ink is not consumed, the communication port 191A is kept in the closed state.

FIG. 10B schematically shows a flow of ink immediately after the recording operation is finished and the circulation pump 500 is changed to an OFF state (stopped state). At a time point where the recording operation is finished and the circulation pump 500 is changed to OFF, both the pressure in the first pressure control chamber 122 and the pressure in the second pressure control chamber 152 are at the control pressure applied during a recording operation. Therefore a movement of ink such as that shown in FIG. 10B occurs in accordance with the differential pressure between the pressure in the first pressure control chamber 122 and the pressure in the second pressure control chamber 152. Specifically, a flow of ink is continuously generated in which the ink is supplied from the first pressure control chamber 122 to the discharge module 300 via the supply flow path 130 and the ink subsequently reaches the second pressure control chamber 152 via the collecting flow path 140. In addition, a flow of ink from the first pressure control chamber 122 to the second pressure control chamber 152 via the bypass flow path 160 and the second valve chamber 151 is also continuously generated.

Due to the flows of ink described above, an amount of ink having moved to the second pressure control chamber 152 from the first pressure control chamber 122 is supplied from the ink tank 2 to the first pressure control chamber 122 via the filter 110 and the first valve chamber 121. Therefore, an inner capacity of the first pressure control chamber 122 is kept constant. Based on the relationship represented by Expression 2 above, when the inner capacity of the first pressure control chamber 122 is constant, the spring force F1 of the valve spring 200, the spring force F2 of the pressure adjustment spring 220, the pressure-receiving area S1 of the valve 190, and the pressure-receiving area S2 of the pressure plate 210 are kept constant. Therefore, the pressure of the first pressure control chamber 122 is determined in accordance with a change in the pressure (gauge pressure) P1 of the first valve chamber 121. Accordingly, when the pressure P1 of the first valve chamber 121 does not change, the pressure P2 of the first pressure control chamber 122 is kept at the same pressure as the control pressure during a recording operation.

On the other hand, the pressure of the second pressure control chamber 152 changes over time in accordance with a change in inner capacity that accompanies an inflow of ink from the first pressure control chamber 122. Specifically, during a period from the state shown in FIG. 10B to the communication port 191 changing to the closed state and the second valve chamber 151 and the second pressure control chamber 152 entering a non-communicated state as shown in FIG. 10C, the pressure of the second pressure control chamber 152 changes in accordance with Expression 2. Subsequently, the pressure plate 210 and the valve shaft 190a change into a non-abutting state and the communication port 191 changes to the closed state. In addition, as shown in FIG. 10D, ink flows into the second pressure control chamber 152 from the collecting flow path 140. During a period from the pressure plate 210 and the flexible member 230 being displaced by the ink inflow to the inner capacity of the second pressure control chamber 152 reaching a maximum value, the pressure of the second pressure control chamber 152 changes in accordance with Expression 4. In other words, the pressure rises.

Once the state shown in FIG. 10C is created, a flow of ink from the first pressure control chamber 122 to the second pressure control chamber 152 via the bypass flow path 160 and the second valve chamber 151 is not generated. Therefore, only a flow of ink in which the ink inside the first pressure control chamber 122 is supplied to the discharge module 300 via the supply flow path 130 and subsequently reaches the second pressure control chamber 152 via the collecting flow path 140 is generated. As described above, the movement of ink from the first pressure control chamber 122 to the second pressure control chamber 152 occurs in accordance with differential pressure between the pressure in the first pressure control chamber 122 and the pressure in the second pressure control chamber 152. Therefore, the movement of the ink stops when the pressure in the first pressure control chamber 122 becomes equal to the pressure in the second pressure control chamber 152.

In addition, in a state where the pressure in the second pressure control chamber 152 is equal to the pressure in the first pressure control chamber 122, the second pressure control chamber 152 expands until reaching the state shown in FIG. 10D. When the second pressure control chamber 152 has expanded as shown in FIG. 10D, a storage portion capable of storing ink is formed in the second pressure control chamber 152. While a transition from a stoppage of the circulation pump 500 to the state shown in FIG. 10D may vary according to shapes and sizes of flow paths and characteristics of ink, the transition generally takes around one to two minutes. When the circulation pump 500 is driven from the state shown in FIG. 10D where ink is stored in the storage portion, the ink in the storage portion is supplied to the first pressure control chamber 122 by the circulation pump 500. Accordingly, as shown in FIG. 10E, an amount of ink in the first pressure control chamber 122 increases and the flexible member 230 and the pressure plate 210 are displaced in an expanding direction. In addition, when driving of the circulation pump 500 is continuously performed, the state in the circulatory path is to change as shown in FIG. 10A.

While FIG. 10A has been described as an example during a recording operation in the description given above, the circulation of ink may be performed without being accompanied by a recording operation. Even in this case, a flow of ink such as that shown in FIGS. 10A to 10E is to be created in accordance with driving and stoppage of the circulation pump 500.

In addition, as described above, while an example where the communication port 191B in the second pressure adjusting means 150 changes to the open state when the circulation pump 500 is driven and circulation of ink is performed and changes to the closed state when the circulation of ink stops is used in the present embodiment, the communication port 191B is not limited thereto. Control pressure may be set so that the communication port 191B in the second pressure adjusting means 150 remains in the closed state even when the circulation pump 500 is driven and circulation of ink is performed. Hereinafter, a specific description will be given together with a description of the function of the bypass flow path 160.

The bypass flow path 160 which connects the first pressure adjusting means 120 and the second pressure adjusting means 150 to each other is provided so that, for example, when negative pressure created in the circulatory path exceeds a prescribed value, the negative pressure does not affect the discharge module 300. In addition, the bypass flow path 160 is also provided in order to supply ink to the pressure chamber 12 from both the supply flow path 130 and the collecting flow path 140.

First, an example in which, when negative pressure exceeds a prescribed value, the negative pressure is prevented from affecting the discharge module 300 by providing the bypass flow path 160 will be described. For example, characteristics (for example, viscosity) of ink may change due to a change in environmental temperature. When the viscosity of ink changes, pressure loss inside the circulatory path also changes. For example, when the viscosity of ink drops, an amount of pressure loss inside the circulatory path decreases. As a result, a flow rate of the circulation pump 500 being driven by a constant drive amount increases and a flow rate through the discharge module 300 also increases.

On the other hand, since the discharge module 300 is kept at a constant temperature by a temperature adjustment mechanism (not illustrated), the viscosity of the ink inside the discharge module 300 is kept constant even if the environmental temperature changes. Due to an increase in the flow rate of ink flowing through the discharge module 300 while the viscosity of the ink in the discharge module 300 remains unchanged, negative pressure in the discharge module 300 increases due to flow resistance. In this manner, when the negative pressure in the discharge module 300 exceeds a prescribed value, there is a risk that a meniscus of the discharge port 13 may break, outside air may be pulled into the circulatory path, and normal discharge may no longer be performed. In addition, even if the meniscus does not break, the negative pressure in the pressure chamber 12 may exceed prescribed pressure and may affect discharge.

Therefore, in the present embodiment, the bypass flow path 160 is formed in the circulatory path. Since providing the bypass flow path 160 causes ink to also flow into the bypass flow path 160 when the negative pressure exceeds a prescribed value, pressure of the discharge module 300 can be kept constant. Therefore, for example, the communication port 191B in the second pressure adjusting means 150 may be configured with control pressure which enables the communication port 191B to remain in the closed state even when the circulation pump 500 is being driven. Furthermore, control pressure in the second pressure adjusting means 150 may be set so that the communication port 191 in the second pressure adjusting means 150 changes to the open state when the negative pressure exceeds a prescribed value. In other words, the communication port 191B may be in the closed state while the circulation pump 500 is being driven if the meniscus stays unbroken even when the flow rate of the pump changes due to a change in the environment such as a change in viscosity or when prescribed negative pressure is maintained.

Next, an example in which the bypass flow path 160 is provided in order to supply ink to the pressure chamber 12 from both the supply flow path 130 and the collecting flow path 140 will be described. A pressure fluctuation in the circulatory path may also occur due to a discharge operation by the discharge element 15. This is because a force that pulls ink into the pressure chamber 12 is created with the discharge operation.

Hereinafter, a situation where ink supplied to the pressure chamber 12 is supplied from both the side of the supply flow path 130 and the side of the collecting flow path 140 when high-duty recording is continued will be described. While a definition of duty may change depending on various conditions, in this case, a state where one ink drop of 4 pl is recorded on a 1200 dpi lattice will be considered 100%. It is assumed that a high-duty recording is recording performed at a duty of, for example, 100%.

When high-duty recording is continued, an amount of ink that flows into the second pressure control chamber 152 from the pressure chamber 12 via the collecting flow path 140 decreases. On the other hand, since the circulation pump 500 creates an outflow of ink in a constant amount, a balance between inflow and outflow in the second pressure control chamber 152 is disrupted, the ink in the second pressure control chamber 152 decreases, the negative pressure in the second pressure control chamber 152 increases, and the second pressure control chamber 152 contracts. In addition, due to an increase in the negative pressure in the second pressure control chamber 152, an inflow amount of ink that flows into the second pressure control chamber 152 via the bypass flow path 160 increases and the second pressure control chamber 152 stabilizes in a balance state between outflow and inflow. In this manner, consequently, the negative pressure in the second pressure control chamber 152 rises in proportion with the duty. Furthermore, as described above, in a configuration in which the communication port 191B is in the closed state while the circulation pump 500 is being driven, the communication port 191B changes to the open state in accordance with the duty and ink is to flow into the second pressure control chamber 152 from the bypass flow path 160.

Furthermore, when high-duty recording is further continued, an amount of ink that flows into the second pressure control chamber 152 from the pressure chamber 12 via the collecting flow path 140 decreases and, instead, an amount of ink that flows into the second pressure control chamber 152 from the communication port 191B via the bypass flow path 160 increases. When this state further continues, the amount of ink that flows into the second pressure control chamber 152 from the pressure chamber 12 via the collecting flow path 140 drops to zero and the ink that flows into the circulation pump 500 becomes entirely constituted of ink that flows in from the communication port 191B. When this state further continues, in turn, ink flows in reverse from the second pressure control chamber 152 into the pressure chamber 12 via the collecting flow path 140. In this state, ink that flows out from the second pressure control chamber 152 to the circulation pump 500 and ink that flows out from the second pressure control chamber 152 to the pressure chamber 12 are to flow into the second pressure control chamber 152 from the communication port 191B through the bypass flow path 160. In this case, the pressure chamber 12 is to be filled by the ink of the supply flow path 130 and the ink of the collecting flow path 140 and the filled ink is to be discharged from the pressure chamber 12.

The counterflow of ink which is created when the recording duty is high is a phenomenon that occurs due to the presence of the bypass flow path 160. In addition, while an example where the communication port 191B in the second pressure adjusting means 150 changes to the open state in accordance with a counterflow of ink has been described above, a counterflow of ink may also occur in a state where the communication port 191B in the second pressure adjusting means 150 is already in the open state. Furthermore, due to the presence of the bypass flow path 160, the counterflow of ink described above may occur even in a configuration where the second pressure adjusting means 150 is not provided.

### Ink Flow Path Configuration of Recording Element Unit

Next, an ink flow path in the recording element unit 20 (discharge module unit) of the recording head 1 according to the first embodiment will be described. FIG. 11A is an exploded perspective view when the recording element unit 20 is viewed from a side of the supporting member 21 and FIG. 11B is an exploded perspective view when the recording element unit 20 is viewed from a side of the discharge module 300. For the sake of simplicity, illustrations of the connecting substrate 22 and the electric substrate 23 are omitted in FIGS. 11A and 11B. Hereinafter, while a description will be given with a focus on an ink flow path of one color of ink (cyan (C) in the drawing), the ink flow paths of other colors are configured in a similar manner.

The ink flow path in the recording element unit 20 is constituted of the supporting member 21 and the discharge module 300. The discharge module 300 is constituted of an opening plate 310 and the recording element substrate 320. As shown in FIG. 11B, the recording element substrate 320 has a surface on which the plurality of discharge ports 13 are formed and the opening plate 310 is connected to a surface on an opposite side to the surface on which the discharge ports 13 are formed. The discharge module 300 is fixed to the supporting member 21 due to the surface of the opening plate 310 on an opposite side to the connecting surface with the recording element substrate 320 being bonded to the supporting member 21.

The supporting member 21 is provided with a plurality of supporting member supply ports 211 for supplying ink and a plurality of supporting member collecting ports 212 for collecting ink. The supporting member supply ports 211 constitute a part of the supply flow path 130 and the supporting member collecting ports 212 constitute a part of the collecting flow path 140. In addition, the opening plate 310 is provided with a plurality of supply openings 311 for supplying ink to the recording element substrate 320 from the supporting member 21 and a plurality of collecting openings 312 for collecting ink to the supporting member 21 from the recording element substrate 320. In other words, the opening plate 310 constitutes an opening forming portion for supplying ink to and collecting ink from the recording element substrate 320 and the supporting member 21. In the first embodiment, the opening forming portion is constituted of two opening plates 310. In addition, the circulation unit 54 causes ink to circulate inside the recording head 1 through the supporting member supply ports 211, the supporting member collecting ports 212, the supply openings 311, and the collecting openings 312.

In the first embodiment, the supporting member supply ports 211 are provided at positions corresponding to the supply openings 311 and the supporting member collecting ports 212 are provided at positions corresponding to the collecting openings 312. In other words, the supporting member supply ports 211 are provided in the same number as the supply openings 311 and the supporting member collecting ports 212 are provided in the same number as the collecting openings 312. In the various drawings, constituent elements of the flow path for ink supply such as the supporting member supply ports 211 and the supply openings 311 will be denoted as IN and constituent elements of the flow path for ink collecting such as the supporting member collecting ports 212 and the collecting openings 312 will be denoted as OUT when appropriate.

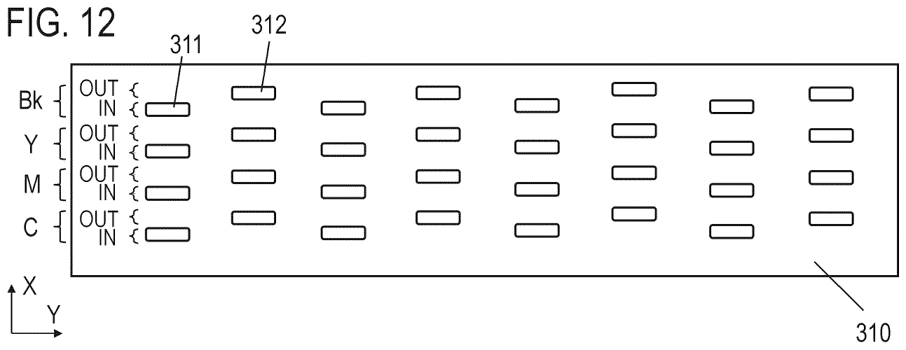

FIG. 12 is a schematic top view of the opening plate 310 as viewed from the side of the supporting member 21. As shown in FIG. 12, the opening plate 310 is provided with the supply openings 311 and the collecting openings 312 for each color of ink. The supply openings 311 and the collecting openings 312 for the same color are alternately arrayed in the Y direction (the direction orthogonal to the main scanning direction). The plurality of supply openings 311 are arranged at equal intervals in the Y direction and the plurality of collecting opening 312 are arranged at equal intervals in the Y direction. The supply openings 311 and the collecting openings 312 for the same color are arranged mutually offset in the X direction. In addition, the supply openings 311 and the collecting openings 312 for each color of ink are respectively lined up in the X direction (main scanning direction).

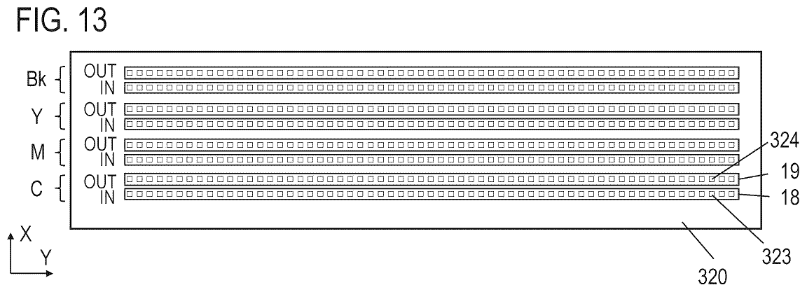

FIG. 13 is a schematic top view of the recording element substrate 320 as viewed from the side of the supporting member 21 (side of the opening plate 310). As shown in FIG. 13, the common supply flow path 18 for supplying ink to the discharge portion and the common collecting flow path 19 for collecting ink from the discharge portion are formed on the side of the opening plate 310 of the recording element substrate 320. The common supply flow path 18 and the common collecting flow path 19 are arranged for each ink type and the opening plate 310 includes four common supply flow paths 18 and four common collecting flow paths 19.

Furthermore, the supply port 323 for supplying ink to the discharge portion is arranged on a side of the discharge portion of the common supply flow path 18 and the collecting port 324 for collecting ink is arranged on a side of the discharge portion of the common collecting flow path 19. The supply port 323 and the collecting port 324 are arranged in the same number as the number of discharge portions in each discharge port array.

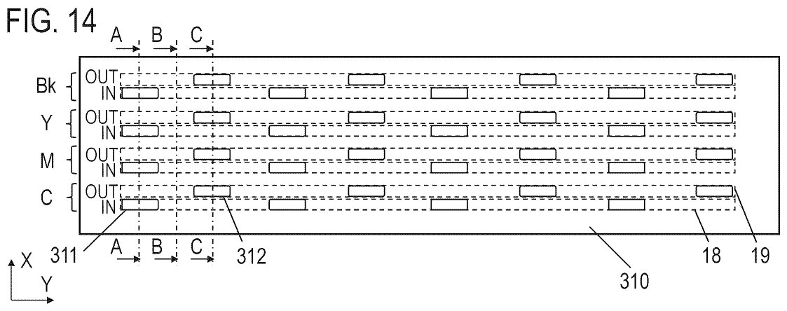

FIG. 14 is an explanatory diagram of a bonding state of the opening plate 310 and the recording element substrate 320 and shows the opening plate 310 and the recording element substrate 320 being bonded to each other from the side of the opening plate 310. FIG. 14 shows a positional relationship between the common supply flow paths 18 and the common collecting flow paths 19 of the recording element substrate 320 depicted by dashed lines and the common supply flow paths 18 and the common collecting flow paths 19 of the opening plate 310 depicted by solid lines. As shown in FIG. 14, the supply openings 311 are arranged at positions corresponding to the common supply flow paths 18 and the collecting openings 312 are arranged at positions corresponding to the common collecting flow paths 19.

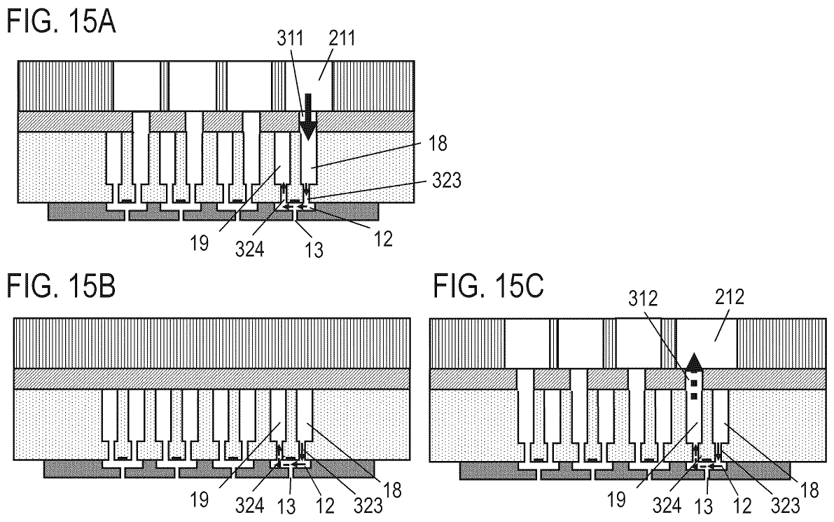

FIGS. 15A to 15C are schematic sectional views showing an ink flow path in the recording element unit 20 and showing a state where the ink flow path is viewed in the Y direction. FIG. 15A shows a section taken along A-A in FIG. 14 which passes through the supply opening 311. FIG. 15B shows a section taken along B-B in FIG. 14 which does not pass through the supply opening 311 and the collecting opening 312. FIG. 15C shows a section taken along C-C in FIG. 14 which passes through the collecting opening 312.

Next, a flow of ink in the ink flow path in the recording element unit 20 will be described. FIGS. 11A and 11B and FIGS. 15A to 15C show arrows indicating a direction in which the ink flows. An arrow depicted by a solid line indicates a direction of a flow of ink which passes through the supply-side ink flow path to be supplied to the recording element substrate 320 and an arrow depicted by a dashed line indicates a direction of a flow of ink which passes through the collecting-side ink flow path to be collected from the recording element substrate 320. Hereinafter, while an ink flow will be described using one discharge portion as an example, the ink flow in each discharge portion is the same.

First, as shown in FIG. 15A, ink is supplied from the circulation unit 54 to the supporting member supply port 211 of the supporting member 21 and, next, ink flows from the supporting member supply port 211 via the supply opening 311 to the common supply flow path 18 of the recording element substrate 320. Subsequently, ink is supplied from the common supply flow path 18 to the pressure chamber 12 via the supply port 323.

In a region where the supply opening 311 is not present as shown in FIGS. 15B and 15C, ink supplied from the supply opening 311 passes through the common supply flow path 18 to be supplied to each pressure chamber 12. At this point, ink flows in the Y direction (a direction orthogonal to the paper plane in FIGS. 15B and 15C) through the common supply flow path 18.

Next, a flow of ink collecting will be described. In ink supplied to the pressure chamber 12, ink not having been discharged from the discharge port 13 flows to the common collecting flow path 19 via the collecting port 324. Subsequently, the ink flows to the supporting member collecting port 212 of the supporting member 21 via the collecting opening 312 to be collected to the circulation unit 54.

In a region where the collecting opening 312 is not present as shown in FIGS. 15A and 15B, ink collected from each pressure chamber 12 passes through the common collecting flow path 19 to be collected by the circulation unit 54 via the collecting opening 312. At this point, ink flows in the Y direction (a direction orthogonal to the paper plane in FIGS. 15A and 15B) through the common collecting flow path 19. Note that when the discharge module 300 and the supporting member 21 are bonded to each other, a region where the respective openings are not present such as shown in FIG. 15B is used as a bonding region.

### Temperature Distribution of Discharge Module

Next, a temperature distribution in the discharge module 300 will be described. In the circulatory recording head 1 described above, the temperature of ink that is collected without being discharged from the discharge port 13 rises since the ink passes through a heater. As a result, ink with a relatively high temperature flows into the common collecting flow path 19 and an effect is created in which the temperature of the recording element substrate 320 is raised across an entire region where the common collecting flow path 19 extends. By contrast, since ink having passed through the circulation unit 54 is supplied to the common supply flow path 18, ink at a lower temperature than the common collecting flow path 19 is to be present in the common supply flow path 18.

In such a region, particularly, a region communicated with the supply opening 311 as shown in FIG. 15A is a region supplied from the side of the supporting member 21 with ink which has passed through the circulation unit 54 and of which a temperature has dropped and the temperature of the region becomes lowest in the common supply flow path 18. In addition, the farther away from the supply opening 311, the weaker the cooling effect of the ink.

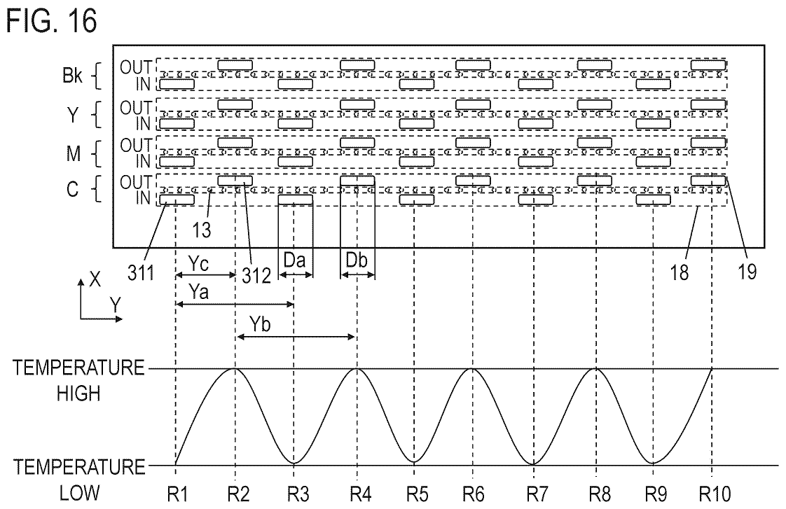

In consideration of the above, a temperature distribution in the discharge module 300 changes in the Y direction. FIG. 16 is an explanatory diagram of the temperature distribution in the discharge module 300. FIG. 16 shows a temperature distribution at arrangement positions of each opening and each flow path in the discharge module 300 and in an outermost discharge port array (the discharge port array for cyan (C)) of the discharge module 300.

As shown in FIG. 16, in the discharge port array direction (Y direction), the supply openings 311 and the collecting openings 312 are alternately arranged. A distance Ya that is an arrangement interval between respective supply openings 311 is equal to a distance Yb that is an arrangement interval between respective collecting openings 312. In addition, an arrangement interval between the supply openings 311 and the collecting openings 312 is a distance Yc. Furthermore, a width Da in the discharge port array direction of the supply openings 311 is equal to a width Db in the discharge port array direction of the collecting openings 312.

Since ink at a relatively low temperature is supplied in regions (R1, R3, R5, R7, and R9 in the graph) where the supply opening 311 is present, the temperature of regions near the supply openings 311 become lower than other regions. Since the farther away from the supply openings 311, the weaker the temperature reduction effect due to supplying ink from the circulation unit 54, the temperature gradually rises and becomes highest in regions (R2, R4, R6, R8, and R10 in the graph) which are farthest from the supply openings 311. In the first embodiment, the regions that are farthest from the supply openings 311 are regions where the collecting openings 312 are present. Due to the effect described above, an undulated temperature distribution such as that shown in FIG. 16 is created in the discharge port array direction.

Such a temperature non-uniformity affects a discharge amount from the discharge port 13 and may cause print non-uniformity. Specifically, print density non-uniformity in which the discharge amount from the discharge port 13 increases and printing becomes darker as the temperature rises while the discharge amount decreases and printing becomes lighter as the temperature drops is created in the discharge port array direction. Such print density non-uniformity becomes conspicuous particularly in scanning heads with a higher print duty than line heads.

Furthermore, in the scanning recording head 1, same colors are preferably arranged in two rows and particularly in a bidirectional manner as shown in FIG. 3 in order to reduce the number of scans. However, when the recording element substrate 320 having such a temperature distribution is arranged by being simply lined up, since discharge port arrays with similar temperature distributions are to be lined up, the print density non-uniformity (print non-uniformity) becomes even more conspicuous. In consideration thereof, in the first embodiment, print non-uniformity is suppressed by changing the arrangement configuration of the supply openings 311 and the collecting openings 312 in the two discharge modules 300.

### Arrangement Configuration of Supply Openings and Recovery Openings

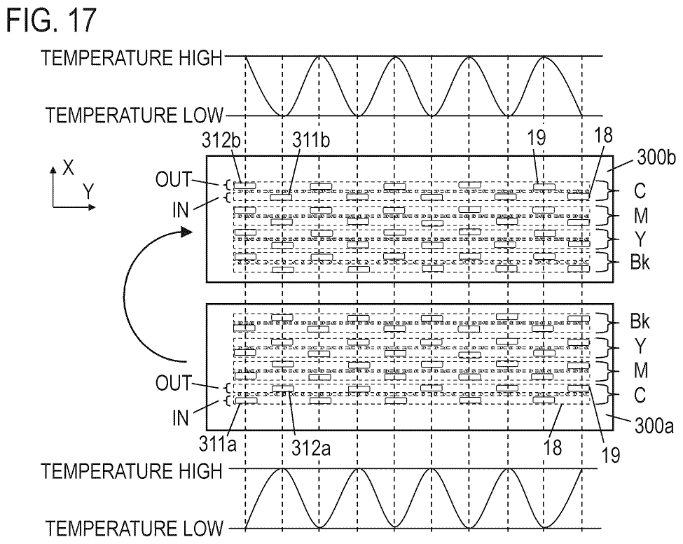

FIG. 17 is an explanatory diagram of an arrangement configuration of the supply openings 311 and the collecting openings 312 in the two discharge modules 300a and 300b according to the first embodiment. FIG. 17 shows a temperature distribution at arrangement positions of each opening and each flow path in the discharge modules 300a and 300b and in outermost discharge port arrays (the discharge port arrays corresponding to cyan (C)) of the respective discharge modules 300a and 300b. Hereinafter, when necessary, the two discharge modules 300a and 300b will be described by making a distinction between the two as a first discharge module 300a and a second discharge module 300b. In addition, when necessary, each opening and each flow path of the first discharge module 300a and the second discharge module 300b will be distinguished by adding suffixes.

In the first embodiment, the recording head 1 is mounted with the first discharge module 300a and the second discharge module 300b so as to line up in a direction intersecting the discharge port array direction. In addition, in the discharge port array direction (Y direction or first direction), arrangement relationships of a first supply opening 311a and a first collecting opening 312a of the first discharge module 300a and a second supply opening 311b and a second collecting opening 312b of the second discharge module 300b are opposite to each other. Specifically, in the discharge port array direction of the recording head 1, the second supply opening 311b is offset with respect to the first supply opening 311a and the second collecting opening 312b is offset with respect to the first collecting opening 312a. In other words, in the main scanning direction (X direction or second direction), the first supply opening 311a and the second supply opening 311b do not overlap with each other and the first collecting opening 312a and the second collecting opening 312b do not overlap with each other. In the first embodiment, in the discharge port array direction of the recording head 1, the first supply opening 311a and the second collecting opening 312b are arranged at a same position and the first collecting opening 312a and the second supply opening 311b are arranged at a same position.

Due to the first discharge module 300a and the second discharge module 300b having the arrangement configurations described above, a temperature distribution waveform of the discharge port array of the first discharge module 300a becomes a shape that is out of phase by a ¼ cycle with respect to the temperature distribution waveform of the discharge port array of the second discharge module 300b. In addition, in the discharge port array direction, a region with the highest temperature in the discharge port array of the first discharge module 300a overlaps with a region with the lowest temperature in the discharge port array of the second discharge module 300b. Furthermore, in the discharge port array direction, a region with the lowest temperature in the discharge port array of the first discharge module 300a overlaps with a region with the highest temperature in the discharge port array of the second discharge module 300b. While the discharge port array for cyan (C) has been described as an example in the description given above, discharge port arrays for other colors of ink have a similar arrangement configuration and a similar temperature distribution.

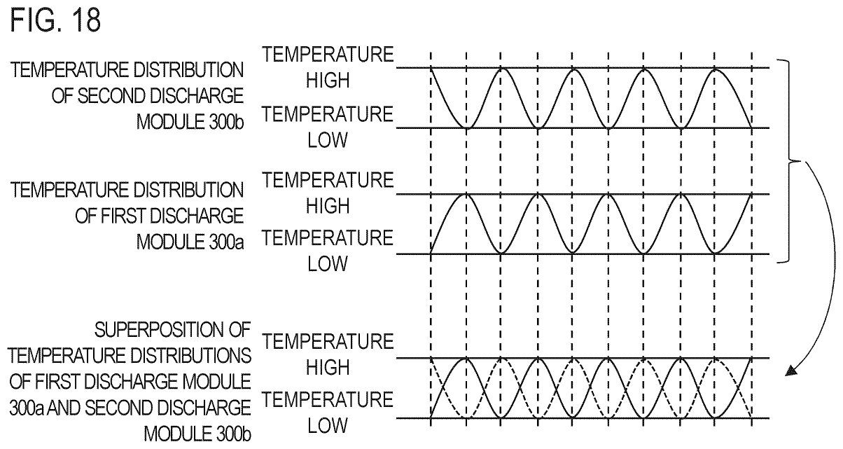

FIG. 18 is an explanatory diagram of a temperature distribution of the discharge port array of the first discharge module 300a and a temperature distribution of the discharge port array of the second discharge module 300b. FIG. 18 shows the temperature distribution of the discharge port array of the first discharge module 300a, the temperature distribution of the discharge port array of the second discharge module 300b, and the two temperature distributions superimposed on each other. As shown in FIG. 18, since the temperature distributions in the discharge port array direction are out of phase by ¼ cycles between the first discharge module 300a and the second discharge module 300b, a region with a high temperature and a region with a low temperature in the respective discharge modules 300 become displaced in the discharge port array direction. Therefore, when printing with two discharge port arrays, print non-uniformity in printing due to the effect of a temperature non-uniformity is suppressed.

As described above, according to the configuration of the first embodiment, since respective openings are arranged so that respective temperature distributions in the discharge port array direction of the discharge port array of the first discharge module 300a and the discharge port array of the second discharge module 300b differ from each other, print non-uniformity in printing can be suppressed. In particular, in the first embodiment, since ink flow paths are configured in such a manner that respective effects due to temperature non-uniformity in the discharge port array direction of the discharge port array of the first discharge module 300a and the discharge port array of the second discharge module 300b cancel each other out, print non-uniformity in printing can be suppressed in an effective manner.

While supplying ink from the supply openings 311 in an ink flow produces a cooling effect as described above, a slight heat dissipation effect is also produced with the collecting openings 312. Therefore, by being arranged at positions in the middle of two supply openings 311 in the discharge port array direction, the collecting openings 312 can suppress a temperature distribution in the discharge port array to no small extent. In other words, a distance Yc that is an arrangement interval between the supply openings 311 and the collecting openings 312 preferably satisfies Yc=Ya/2, where Ya denotes a distance being an arrangement interval between respective supply openings 311. In a similar manner, the distance Yc preferably satisfies Yc=Yb/2, where Yb denotes a distance being an arrangement interval between respective collecting openings 312. Therefore, desirably, the number of arranged supply openings 311 and the number of arranged collecting openings 312 are the same or either one is larger than the other by one. In addition, adopting such a relationship between the numbers of arranged openings enables even pressure loss non-uniformity in flow paths to be suppressed.

### Second Embodiment

Next, a second embodiment according to the present invention will be described. The second embodiment differs from the first embodiment in the arrangement configurations of the supply openings 311 and the collecting openings 312. Hereinafter, in the description of the second embodiment, components similar to those of the first embodiment will be denoted by same reference characters and descriptions thereof will be omitted, and only characteristic components of the second embodiment will be described.

In the first embodiment, the supply openings 311 and the collecting openings 312 of each color are all arranged side by side in the main scanning direction in one discharge module 300. When adopting such a configuration, there may be a need to widen the intervals in the main scanning direction between respective supply openings 311 in the discharge module 300 in order to form the supporting member supply port 211 of the supporting member 21. In a similar manner, there may be a need to widen the intervals in the main scanning direction between respective collecting openings 312 in the discharge module 300 in order to form the supporting member collecting port 212 of the supporting member 21. In this case, since the intervals between respective discharge port arrays corresponding to the openings are also widened in the main scanning direction as a consequence, adopting such a configuration may lead to increasing the sizes of the discharge module 300 and the recording head 1. In consideration thereof, in the second embodiment, in order to prevent intervals between respective discharge port arrays from widening in the main scanning direction, positions of the supply openings 311 and the collecting openings 312 are displaced between respective discharge port arrays in the same discharge module 300.

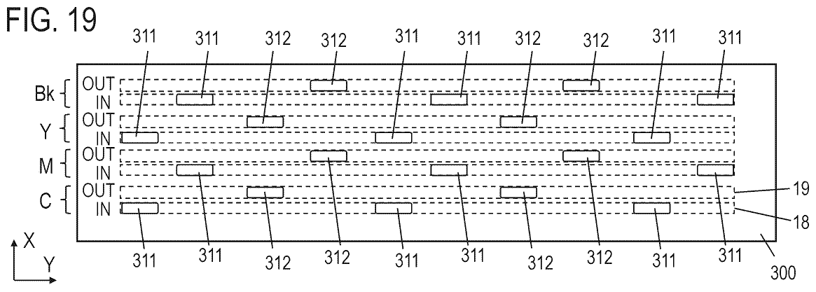

FIG. 19 is an explanatory diagram of a bonding state of the opening plate 310 and the recording element substrate 320 according to the second embodiment and shows the opening plate 310 and the recording element substrate 320 being bonded to each other from the side of the opening plate 310. FIG. 19 shows a positional relationship between the common supply flow paths 18 and the common collecting flow paths 19 of the recording element substrate 320 depicted by dashed lines and the common supply flow paths 18 and the common collecting flow paths 19 of the opening plate 310 depicted by solid lines.

In the second embodiment, the supply openings 311 and the collecting openings 312 of adjacent discharge port arrays are arranged so as to be mutually offset in the discharge port array direction (Y direction). For example, in the discharge port array for magenta (M), the supply openings 311 and the collecting openings 312 are displaced in the discharge port array direction with respect to the discharge port array for cyan (C) and the discharge port array for yellow (Y) which are adjacent in the main scanning direction (X direction). In the second embodiment, the supply openings 311 and the collecting openings 312 are arranged in a similar manner in the discharge port array for cyan (C) and the discharge port array for yellow (Y) and the supply openings 311 and the collecting openings 312 are arranged in a similar manner in the discharge port array for magenta (M) and the discharge port array for black (K).

Even in such an arrangement configuration, temperature non-uniformity may occur in the discharge port array direction in each discharge port array. In consideration thereof, even in the second embodiment, the recording head 1 is configured in such a manner that positions of the first supply opening 311a and the second supply opening 311b in the discharge port array direction in discharge port arrays of a same ink color are mutually offset between the first discharge module 300a and the second discharge module 300b. In a similar manner, positions of the first collecting opening 312a and the second collecting opening 312b are mutually offset in the discharge port array direction in discharge port arrays of a same ink color.

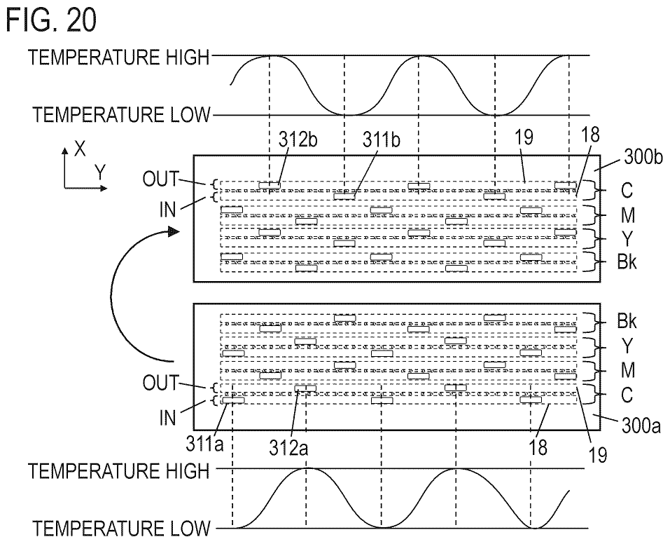

FIG. 20 is an explanatory diagram of an arrangement configuration of the supply openings 311 and the collecting openings 312 in the first discharge module 300a and the second discharge module 300b according to the second embodiment. FIG. 20 shows a temperature distribution at arrangement positions of each opening and each flow path of the respective discharge modules 300a and 300b and in outermost discharge port arrays (the discharge port arrays for cyan (C)) of the respective discharge modules 300a and 300b. In the second embodiment, the arrangement relationships of the respective openings of the first discharge module 300a and the second discharge module 300b are point symmetric to each other.

Due to the respective openings being arranged as described above, in the discharge port array direction of the recording head 1 (the Y direction or the first direction), the first supply opening 311a and the second supply opening 311b are arranged in a displaced manner and the first collecting opening 312a and the second collecting opening 312b are arranged in a displaced manner between discharge port arrays of the same color. In the second embodiment, in discharge port arrays for cyan (C), the first supply opening 311a, the first collecting opening 312a, the second supply opening 311b, and the second collecting opening 312b are arranged at mutually different positions in the discharge port array direction.

Due to the first discharge module 300a and the second discharge module 300b having the arrangement configurations described above, a temperature distribution waveform of the discharge port array of the first discharge module 300a becomes a shape that is out of phase by a ¼ cycle with respect to the temperature distribution waveform of the discharge port array of the second discharge module 300b. Therefore, when discharge port arrays for the same color are compared with each other, a region with the highest temperature in the discharge port array of the first discharge module 300a and a region with the highest temperature in the discharge port array of the second discharge module 300b are at different positions in the discharge port array direction. In a similar manner, a region with the lowest temperature in the discharge port array of the first discharge module 300a and a region with the lowest temperature in the discharge port array of the second discharge module 300b are at different positions in the discharge port array direction. While the discharge port array for cyan (C) has been described as an example in the description given above, discharge port arrays for other colors of ink have a similar arrangement configuration and a similar temperature distribution.

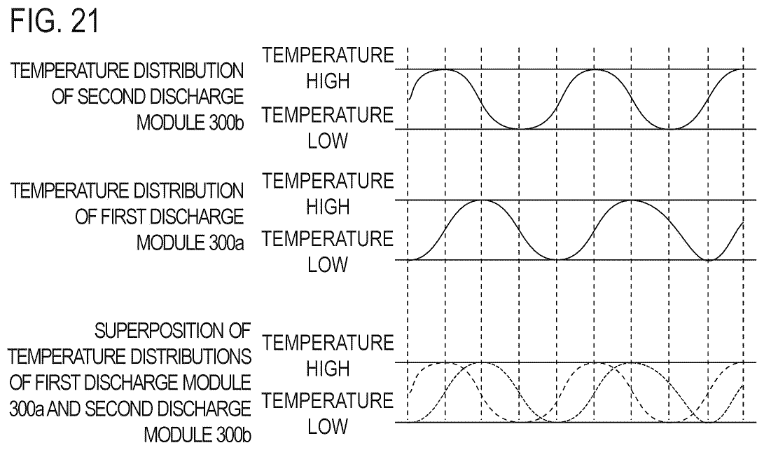

FIG. 21 is an explanatory diagram of a temperature distribution of the discharge port array of the first discharge module 300a and a temperature distribution of the discharge port array of the second discharge module 300b according to the second embodiment. FIG. 21 shows the temperature distribution of the discharge port array of the first discharge module 300a, the temperature distribution of the discharge port array of the second discharge module 300b, and the two temperature distributions superimposed on each other. As shown in FIG. 21, since the temperature distributions in the discharge port array direction are out of phase by ¼ cycles between the first discharge module 300a and the second discharge module 300b, a region with a high temperature and a region with a low temperature in the respective discharge modules 300 become displaced in the discharge port array direction. Therefore, when printing with two discharge port arrays, print non-uniformity in printing due to the effect of a temperature non-uniformity is suppressed.

As described above, according to the configuration of the second embodiment, since respective openings are arranged so that respective temperature distributions in the discharge port array direction of the discharge port array of the first discharge module 300a and the discharge port array of the second discharge module 300b differ from each other, print non-uniformity in printing can be suppressed. Furthermore, according to the configuration of the second embodiment, since intervals of the respective openings in the main scanning direction need not be excessively widened, an increase in the sizes of the discharge module 300 and the recording head 1 in the main scanning direction can be suppressed.

If respective supply openings 311 or respective collecting openings 312 are arranged so as to be mutually displaced in the discharge port array direction in two discharge port arrays as in the configuration of the second embodiment, an effect of suppressing print non-uniformity in printing is obtained to no small extent. Therefore, a configuration in which only respective supply openings 311 are displaced in the discharge port array direction and a configuration in which only respective collecting openings 312 are displaced in the discharge port array direction are also conceivable as modifications of the present invention.

In order to effectively produce an effect of suppressing print non-uniformity in printing, the first supply opening 311a and the second supply opening 311b are preferably arranged at positions that completely avoid overlapping with each other in the main scanning direction. Therefore, an amount of displacement in the discharge port array direction between the first supply opening 311a and the second supply opening 311b is preferably at least Da and not more than Ya/2 (where Da denotes a width in the discharge port array direction of the supply openings 311 and Ya denotes an arrangement interval in the discharge port array direction of the supply openings 311). In addition, an amount of displacement in the discharge port array direction between the first collecting opening 312a and the second collecting opening 312b is preferably at least Db and not more than Yb/2 (where Db denotes a width in the discharge port array direction of the collecting openings 312 and Yb denotes an arrangement interval in the discharge port array direction of the collecting openings 312).

### Third Embodiment

Next, a third embodiment according to the present invention will be described. The third embodiment differs from the second embodiment in that the recording head 1 is constituted of a single discharge module 300 including a single recording element substrate 320.

In the third embodiment, the first discharge module 300a and the second discharge module 300b according to the second embodiment are configured as an integrated discharge module 300. In other words, two discharge port arrays of each color for a total of eight discharge port arrays are formed on the recording element substrate 320 of the discharge module 300 according to the third embodiment. In addition, the first supply opening 311a, the first collecting opening 312a, the second supply opening 311b, and the second collecting opening 312b are all formed in the discharge module 300 according to the third embodiment. Arrangement positions of the supply openings 311 and the collecting openings 312 which are provided so as to correspond to each discharge port array are similar to those of the second embodiment.

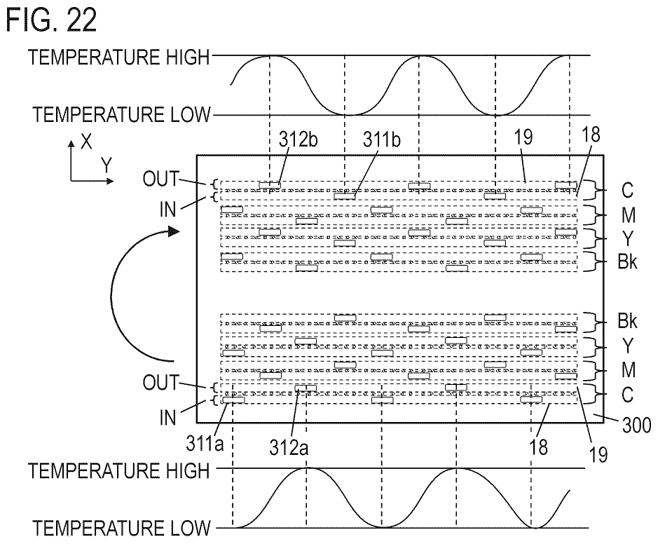

FIG. 22 is an explanatory diagram of an arrangement configuration of the supply openings 311 and the collecting openings 312 in the discharge module 300 according to the third embodiment. FIG. 22 shows a temperature distribution at arrangement positions of each opening and each flow path in the discharge module 300 and in an outermost discharge port array (the discharge port array for cyan (C)) of the discharge module 300. Even in this configuration, in the discharge port array direction of the recording head 1 (the Y direction or the first direction), the first supply opening 311a and the second supply opening 311b are arranged in an offset manner and the first collecting opening 312a and the second collecting opening 312b are arranged in an offset manner between discharge port arrays of the same color. According to such a configuration, since a region with a high temperature and a region with a low temperature are displaced in the discharge port array direction between discharge port arrays of the same color of the discharge module 300, when printing with two discharge port arrays, print non-uniformity in printing due to the effect of a temperature non-uniformity is suppressed.

As described above, according to the configuration of the third embodiment, since respective openings are arranged so that respective temperature distributions in the discharge port array direction of the discharge port array of the first discharge module 300a and the discharge port array of the second discharge module 300b differ from each other, print non-uniformity in printing can be suppressed. Furthermore, according to the configuration of the third embodiment, since the recording head 1 can be constituted of a single recording element substrate 320 and a single discharge module 300, the number of recording element substrates can be reduced.

While the recording head 1 is provided with a thermoelectric conversion element as an energy generation element that discharges liquid in the embodiments described above, the present invention is not limited to such a configuration. For example, the present invention is applicable to any configuration such as liquid discharge heads that adopt a discharge system of discharging a liquid using a piezoelectric element or liquid discharge heads that adopt other discharge systems as long as a temperature of ink changes during ink discharge.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-076761, filed on May 8, 2023, which is hereby incorporated by reference herein in its entirety.

What is claimed is:

1. A liquid discharge head, comprising:
a first discharge port array configured of a plurality of discharge ports lined up in a first direction from which a liquid is discharged;
a second discharge port array configured of a plurality of discharge ports lined up in the first direction, the second discharge port array being arranged at a position overlapping with the first discharge port array in a second direction orthogonal to the first direction in a case of being viewed from a discharge direction of the liquid;
an opening forming portion including a first supply opening for supplying the liquid to a discharge port of the first discharge port array, a first collecting opening for collecting the liquid that has not been discharged from the discharge port of the first discharge port array, a second supply opening for supplying the liquid to a discharge port of the second discharge port array, and a second collecting opening for collecting the liquid that has not been discharged from the discharge port of the second discharge port array; and
a circulatory portion which causes the liquid to circulate through the first supply opening, the first collecting opening, the second supply opening, and the second collecting opening,
wherein the second supply opening is offset in the first direction with respect to the first supply opening.

2. The liquid discharge head according to claim 1,
wherein the second supply opening is arranged at a position that does not overlap with the first supply opening in the second direction.

3. The liquid discharge head according to claim 1,
wherein the second collecting opening is arranged so as to be displaced in the first direction with respect to the first collecting opening.

4. The liquid discharge head according to claim 1,
wherein the second supply opening is arranged at a position that overlaps with the first collecting opening in the second direction, and
wherein the second collecting opening is arranged at a position that overlaps with the first supply opening in the second direction.

5. The liquid discharge head according to claim 1,
wherein the first supply opening, the first collecting opening, the second supply opening, and the second collecting opening are arranged by being lined up respectively in plurality in the first direction.

6. The liquid discharge head according to claim 5,
wherein the plurality of first supply openings and the plurality of second supply openings are arranged at equal intervals in the first direction, and
wherein in a case where a width in the first direction of the first supply opening is denoted by Da and an arrangement interval of the first supply openings is denoted by Ya, an amount of displacement in the first direction of the second supply opening with respect to the first supply opening is at least Da and not more than Ya/2.

7. A liquid discharge head, comprising:
a first discharge port array configured of a plurality of discharge ports lined up in a first direction from which a liquid is discharged;
a second discharge port array configured of a plurality of discharge ports lined up in the first direction, the second discharge port array being arranged at a position overlapping with the first discharge port array in a second direction orthogonal to the first direction in a case of being viewed from a discharge direction of the liquid;
an opening forming portion including a first supply opening for supplying the liquid to a discharge port of the first discharge port array, a first collecting opening for collecting the liquid that has not been discharged from the discharge port of the first discharge port array, a second supply opening for supplying the liquid to a discharge port of the second discharge port array, and a second collecting opening for collecting the liquid that has not been discharged from the discharge port of the second discharge port array; and
a circulatory portion which causes the liquid to circulate through the first supply opening, the first collecting opening, the second supply opening, and the second collecting opening,
wherein the second collecting opening is offset in the first direction with respect to the first collecting opening.

8. The liquid discharge head according to claim 7,
wherein the second collecting opening is arranged at a position that does not overlap with the first collecting opening in the second direction.

9. The liquid discharge head according to claim 7,
wherein the first supply opening, the first collecting opening, the second supply opening, and the second collecting opening are arranged by being lined up respectively in plurality in the first direction.

10. The liquid discharge head according to claim 9,
wherein the plurality of first collecting openings and the plurality of second collecting openings are arranged at equal intervals in the first direction, and
wherein in a case where a width in the first direction of the first collecting opening is denoted by Db and an arrangement interval of the first collecting openings is denoted by Yb, an amount of displacement in the first direction of the second collecting opening with respect to the first collecting opening is at least Db and not more than Yb/2.

11. The liquid discharge head according to claim 1,
wherein the second direction is a scanning direction of the liquid discharge head.

12. The liquid discharge head according to claim 1,
wherein discharge ports of the first discharge port array and the second discharge port array are discharge ports for discharging ink of a same color.

13. The liquid discharge head according to claim 1, further comprising a thermal resistive element which generates heat for discharging the liquid.

14. The liquid discharge head according to claim 7,
wherein the second direction is a scanning direction of the liquid discharge head.

15. The liquid discharge head according to claim 7,
wherein discharge ports of the first discharge port array and the second discharge port array are discharge ports for discharging ink of a same color.

16. The liquid discharge head according to claim 7, further comprising a thermal resistive element which generates heat for discharging the liquid.
